(19) United States
(12) Patent Application Publication
(10) Pub. No.: US 2023/0118961 A1
(43) Pub. Date: Apr. 20, 2023

(54) ELECTROCHEMICAL CELLS AND ELECTRODES WITH CARBON-CONTAINING COATINGS AND METHODS OF PRODUCING THE SAME

(71) Applicant: 24M Technologies, Inc., Cambridge, MA (US)

(72) Inventors: Junzheng CHEN, Concord, MA (US); Naoki OTA, Lexington, MA (US); Xiaoming LIU, Newton, MA (US); Yuki KUSACHI, Burlington, MA (US)

(21) Appl. No.: 18/085,160

(22) Filed: Dec. 20, 2022

Related U.S. Application Data
(63) Continuation of application No. PCT/US2021/038921, filed on Jun. 24, 2021.
(60) Provisional application No. 63/158,002, filed on Mar. 8, 2021.
(60) Provisional application No. 63/115,387, filed on Nov. 18, 2020.
(60) Provisional application No. 63/108,560, filed on Nov. 2, 2020.
(60) Provisional application No. 63/043,231, filed on Jun. 24, 2020.

(51) Int. Cl. H01M 50/451; H01M 4/04; H01M 4/62; H01M 4/58; H01M 50/403

(52) U.S. Cl. CPC H01M 50/451; H01M 4/0404; H01M 4/625; H01M 4/58; H01M 50/403; H01M 2004/021

(57) ABSTRACT

Embodiments described herein relate generally to electrochemical cells and electrodes with carbon-containing coatings. In some embodiments, an electrochemical cell can include an anode disposed on an anode current collector, a cathode disposed on a cathode current collector, and a separator disposed between the anode and the cathode. The separator has a first side adjacent to the cathode and a second side adjacent to the anode. The electrochemical cell further includes a coating layer disposed on the separator. The coating layer reduces dendrite formation in the electrochemical cell. In some embodiments, the coating layer can include hard carbon. In some embodiments, the coating layer can have a thickness between about 100 nm and about 20 μm. In some embodiments, the coating layer can be disposed on the first side of the separator.

### RELATED APPLICATIONS

This application claims priority to and benefit of U.S. Provisional Application No. 63/043,231, entitled “Electrochemical Cells with Multi-Layered Electrodes and Coated Separators and Methods of Making the Same,” and filed Jun. 24, 2020; U.S. Provisional Application No. 63/108,560, entitled “Electrochemical Cells with Multi-Layered Electrodes and Coated Separators and Methods of Making the Same,” and filed Nov. 2, 2020; U.S. Provisional Application No. 63/115,387, entitled “Electrochemical Cells with Multi-Layered Electrodes and Coated Separators and Methods of Making the Same,” and filed Nov. 18, 2020; and U.S. Provisional Application No. 63/158,002, entitled “Electrochemical Cells with Multi-Layered Electrodes and Coated Separators and Methods of Making the Same,” and filed Mar. 8, 2021; the disclosure of each of which is hereby incorporated by reference in their entirety.

### TECHNICAL FIELD

Embodiments described herein relate generally to electrochemical cells and electrodes with carbon-containing coatings.

### BACKGROUND

Embodiments described herein relate to electrodes and electrochemical cells that include coatings with carbon. Electroactive species can nucleate near the surfaces of electrodes, causing dendrites to form in electrochemical cells. Similar phenomena lead to plating or plate formation on or near electrodes. In some cases, dendrites form out of lithium ions migrating to a nucleation site. Dendrites can grow when additional lithium ions migrate to the nucleation site and bind to the nucleation site. Dendrite growth and plating are can be exacerbated by fast charging and discharging of electrochemical cells, as faster charge and discharge lead to a higher density of ion movement. Dendrite formation has several disadvantages in electrochemical cells. The electroactive material that forms the dendrites becomes unusable and the energy that can be derived from the electroactive material is lost from future cycles. This hinders capacity retention. Dendrites can also cause short circuiting in electrochemical cells. Short circuiting can form hot spots in the electrochemical cells, ultimately leading to fires. By directing the movement of electroactive species in electrochemical cells, dendrite formation can be prevented.

### SUMMARY

Embodiments described herein relate generally to electrochemical cells and electrodes with carbon-containing coatings. In some embodiments, an electrochemical cell can include an anode disposed on an anode current collector, a cathode disposed on a cathode current collector, and a separator disposed between the anode and the cathode. The separator has a first side adjacent to the cathode and a second side adjacent to the anode. The electrochemical cell further includes a coating layer disposed on the separator. The coating layer reduces dendrite formation in the electrochemical cell. In some embodiments, the coating layer can include hard carbon. In some embodiments, the coating layer can have a thickness between about 100 nm and about 20 μm. In some embodiments, the coating layer can be disposed on the first side of the separator. In some embodiments, the coating layer can be a first coating layer, and the electrochemical cell can further include a second coating layer, the second coating layer disposed on the second side of the separator. In some embodiments, the second coating layer can include Al₂O₃.

### BRIEF DESCRIPTION OF THE DRAWINGS

FIG. 1 is a block diagram an electrochemical cell with one or more coating layers, according to an embodiment.

FIG. 2 is a schematic illustration of an electrochemical cell with a coating layer, according to an embodiment.

FIG. 3 is a schematic illustration of an electrochemical cell with a coating layer, according to an embodiment.

FIG. 4 is a schematic illustration of an electrochemical cell with multiple coating layers, according to an embodiment.

FIGS. 5A-5B are illustrations of an electrochemical cell with a coating layer, according to an embodiment.

FIG. 6 is a block diagram of a method of forming an electrode with a coating layer, according to an embodiment.

FIG. 7 is a graphical representation of initial capacity loss in different electrochemical cell configurations.

FIG. 8 is a graphical representation of capacity retention vs. number of cycles in different electrochemical cell configurations.

FIG. 9 is a graphical representation of capacity retention vs. number of cycles and C-rate in different electrochemical cell configurations.

FIG. 10 is a graphical representation of capacity retention vs. number of cycles and C-rate in different electrochemical cell configurations.

FIGS. 11A-11B are graphical representations of capacity retention vs. number of cycles in different electrochemical cell configurations.

FIG. 12 is a graphical representation of capacity retention vs. number of cycles and C-rate in different electrochemical cell configurations.

FIG. 13 is a graphical representation of dQ/dV and voltage profile comparisons between different electrochemical cell configurations.

FIGS. 14A-14B show potential vs. distance plots during discharge and rapid charge.

FIG. 15 shows a photographic comparison of hard carbon coating on a separator without a binder and with a binder.

### DETAILED DESCRIPTION

Embodiments described herein relate generally to electrochemical cells and electrodes with carbon-containing coatings. Carbon-containing coatings can aid in directing the flow of electroactive species such that dendrite formation is prevented or substantially prevented. Without wishing to be bound by any particular theory, carbon-containing layers have high ionic conductivity and are able to transport electroactive materials easily, preventing the electroactive materials from becoming stationary and creating nucleation sites for more ions. In some embodiments, a carbon-containing coating can be coated on the cathode. In some embodiments, the carbon-containing coating can be coated on the anode. In some embodiments, the carbon-containing coating can be coated on the separator adjacent to the cathode. In some embodiments, the carbon-containing coating can be coated on the separator, adjacent to the anode. By reducing dendrite formation in electrochemical cells, capacity retention can be improved.

In some embodiments, electrodes described herein can be semi-solid electrodes. In comparison to conventional electrodes, semi-solid electrodes can be made (i) thicker (e.g., greater than about 250 μm-up to about 2,000 μm or even greater) due to the reduced tortuosity and higher electronic conductivity of semi-solid electrodes, (ii) with higher loadings of active materials, (iii) with a simplified manufacturing process utilizing less equipment, and (iv) can be operated between a wide range of C-rates while maintaining a substantial portion of their theoretical charge capacity. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein, are binderless and/or do not use binders that are used in conventional battery manufacturing. Instead, the volume of the electrode normally occupied by binders in conventional electrodes, is now occupied, by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes.

Since the semi-solid electrodes described herein can be made substantially thicker than conventional electrodes, the ratio of active materials (i.e., the semi-solid cathode and/or anode) to inactive materials (i.e. the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein. The use of semi-solid, binderless electrodes can also be beneficial in the incorporation of an overcharge protection mechanism, as generated gas can migrate to the electrode/current collector interface without binder particles inhibiting the movement of the gas within the electrode.

In some embodiments, the electrode materials described herein can be a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in a liquid electrolyte to produce a semi-solid electrode. Examples of electrochemical cells that include a semi-solid and/or binderless electrode material are described in U.S. Pat. No. 8,993,159 entitled, “Semi-solid Electrodes Having High Rate Capability,” filed Apr. 29, 2013 (“the '159 patent”), the disclosure of which is incorporated herein by reference in its entirety.

In some embodiments, electrodes described herein can have a concentration gradient along the thickness of the electrodes (i.e., in the “z-direction.”). Examples of electrodes with multiple layers and/or compositional gradients can be found in U.S. Patent Publication No. US 2019/0363351, filed May 24, 2019 (the '351 publication), entitled “High Energy-Density Composition Gradient Electrodes and Methods of Making the Same,” the entire disclosure of which is incorporated herein by reference.

While electrochemical cells with multiple layers or compositional gradients in the anode and/or cathode can deliver high capacity and high C-rates, charging at high C-rates can lead to cycling issues. Charging or discharging at high C-rates can cause lithium ions or other electroactive species to plate around the edges of the cathode, more so than at low C-rates, due to the high volume of ion movement. Additionally, charging or discharging at high C-rates can exacerbate dendrite growth for the same reasons. Over many cycles, dendrites can consume electroactive material and electrolyte in the electrochemical cells, causing irreversible capacity loss. When dendrites grow large enough, they can penetrate the separator, causing a partial short circuit or a full short circuit in the electrochemical cell. Short circuits can be a safety hazard, as they can potentially lead to ignition and fires in the electrochemical cell.

Coatings on the separator can reduce plating and dendrite growth via several mechanisms. Separator porosity is often a parameter with a relatively narrow workable range, depending on the chemistry of the electrochemical cell. Ion congestion can occur near separator pores. If a high porosity and/or high surface area material is used to coat the separator, the coating can increase the number of possible flow paths ions can follow when migrating from one electrode to the other. This can significantly reduce the congestion of ions near the separator pores, as the ions can migrate through a branched network of pores rather than single file. This reduction in ion congestion can aid in preventing dendrite buildup, thereby improving capacity retention of the electrochemical cell through multiple cycles.

As used herein, “composition” can be anisotropic and can refer to physical, chemical, or electrochemical composition or combinations thereof. For example, in some embodiments, the electrode material directly adjacent to a surface of a current collector can be less porous than electrode material further from the surface of the current collector. Without wishing to be bound by any particular theory, the use of a porosity gradient, for example, may result in an electrode that can be made thicker without experiencing reduced ionic conductivity. In some embodiments, the composition of the electrode material adjacent to the surface of the current collector can be different chemically than the electrode material further from the surface of the current collector.

As used herein, the term “about” and “approximately” generally mean plus or minus 10% of the value stated, e.g., about 250 μm would include 225 μm to 275 μm, about 1,000 μm would include 900 μm to 1,100 μm.

As used herein, the term “semi-solid” refers to a material that is a mixture of liquid and solid phases, for example, such as particle suspension, colloidal suspension, emulsion, gel, or micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L) of the materials included for the electrochemical cell to operate such as, the electrodes, the separator, the electrolyte, and the current collectors. Specifically, the materials used for packaging the electrochemical cell are excluded from the calculation of volumetric energy density.

As used herein, the terms “high-capacity materials” or “high-capacity anode materials” refer to materials with irreversible capacities greater than 300 mAh/g that can be incorporated into an electrode in order to facilitate uptake of electroactive species. Examples include tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

As used herein, the term “composite high-capacity electrode layer” refers to an electrode layer with both a high-capacity material and a traditional anode material, e.g., a silicon-graphite layer.

As used herein, the term “solid high-capacity electrode layer” refers to an electrode layer with a single solid phase high-capacity material, e.g., sputtered silicon, tin, tin alloy such as Sn—Fe, tin mono oxide, silicon, silicon alloy such as Si—Co, silicon monoxide, aluminum, aluminum alloy, mono oxide metal (CoO, FeO, etc.) or titanium oxide.

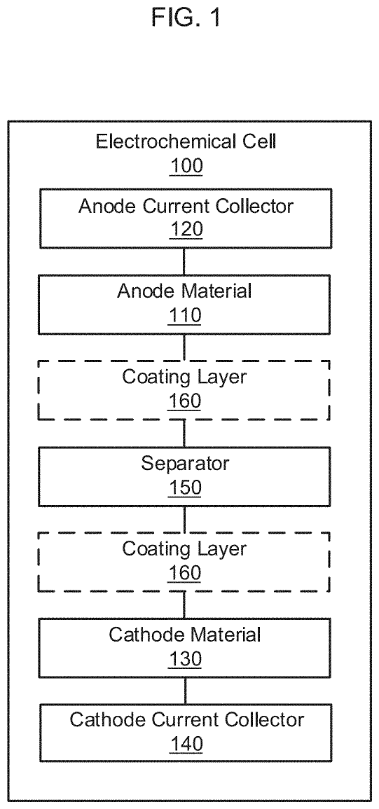

FIG. 1 is a schematic illustration of an electrochemical cell 100, including an anode material 110 disposed on an anode current collector 120, a cathode material 130 disposed on a cathode current collector 140, with a separator 150 disposed therebetween. The electrochemical cell 100 includes a coating layer 160 disposed on one or both sides of the separator 150. In some embodiments, the coating layer 160 can be disposed on the anode material 110 adjacent to the separator 150. In some embodiments, the coating layer 160 can be disposed on the cathode material 130 adjacent to the separator 150. In some embodiments, the coating layer 160 can be disposed on the separator 150 adjacent to the anode material 110. In some embodiments, the coating layer 160 can be disposed on the separator 150 adjacent to the cathode material 130.

In some embodiments, the anode material 110 and/or the cathode material 130 can have multiple layers or concentration gradients, as described in the '351 publication. In some embodiments, the anode material 110 can include a first layer with a first porosity and a second layer with a second porosity, the second porosity different from the first porosity. In some embodiments, the anode material 110 can include a first layer with a first energy density and a second layer with a second energy density, the second energy layer different from the first energy density. In some embodiments, the anode material 110 can include a first layer with a first surface area and a second layer with a second surface area, the second surface area different from the first surface area. In some embodiments, the cathode material 130 can include a first layer with a first porosity and a second layer with a second porosity, the second porosity different from the first porosity. In some embodiments, the cathode material 130 can include a first layer with a first energy density and a second layer with a second energy density, the second energy layer different from the first energy density. In some embodiments, the cathode material 130 can include a first layer with a first surface area and a second layer with a second surface area, the second surface area different from the first surface area. In some embodiments, the anode material 110 and/or the cathode material 130 can be semi-solid electrodes, the same or substantially similar to those described in the '159 patent. In some embodiments, the anode current collector 120 and/or the cathode current collector 140 can be the same or substantially similar to the current collectors described in the '159 patent.

In some embodiments, the anode current collector 120 and/or the cathode current collector 140 can include a conductive material in the form of a substrate, sheet or foil, or any other form factor. In some embodiments, the anode current collector 120 and/or the cathode current collector 140 can include a metal such as aluminum, copper, lithium, nickel, stainless steel, tantalum, titanium, tungsten, vanadium, or a mixture, combinations or alloys thereof. In some embodiments, the anode current collector 120 and/or the cathode current collector 140 can include a non-metal material such as carbon, carbon nanotubes, or a metal oxide (e.g., TiN, TiB₂, MoSi₂, n-BaTiO₃, Ti2O₃, ReO₃, RuO₂, IrO₂, etc.). In some embodiments, the anode current collector 120 and/or the cathode current collector 140 can include a conductive coating disposed on any of the aforementioned metal and non-metal materials. In some embodiments, the conductive coating can include a carbon-based material, conductive metal and/or non-metal material, including composites or layered materials.

In some embodiments, the anode material 110 and/or the cathode material 130 can include an active material, a conductive material, an electrolyte, an additive, a binder, and/or combinations thereof. In some embodiments, the active material can be an ion storage material and or any other compound or ion complex that is capable of undergoing Faradaic or non-Faradaic reactions in order to store energy. The active material can also be a multi-phase material including a redox-active solid mixed with a non-redox-active phase, including solid-liquid suspensions, or liquid-liquid multiphase mixtures, including micelles or emulsions having a liquid ion-storage material intimately mixed with a supporting liquid phase. Systems that utilize various working ions can include aqueous systems in which Li⁺, Na⁺, or other alkali ions are the working ions, even alkaline earth working ions such as Ca²⁺, Mg²⁺, or Al³⁺. In some embodiments, a negative electrode storage material and a positive electrode storage material may be electrochemically coupled to form the electrochemical cell, the negative electrode storing the working ion of interest at a lower absolute electrical potential than the positive electrode. The cell voltage can be determined approximately by the difference in ion-storage potentials of the two ion-storage electrode materials.

In some embodiments, the thickness of the anode material 110 and/or the cathode material 130 can be at least about 30 μm. In some embodiments, the anode material 110 and/or the cathode material 130 can include a semi-solid electrode with a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 600 μm, at least about 700 μm, at least about 800 μm, at least about 900 μm, at least about 1,000 μm, at least about 1,500 μm, and up to about 2,000 μm, inclusive of all thickness values therebetween.

In some embodiments, the anode material 110 can include multiple layers of electrode material. In some embodiments, the anode material 110 can include a semi-solid electrode material. In some embodiments, the anode material 110 can include conventional electrode materials. In some embodiments, the anode material 110 can include a solid electrode material. In some embodiments, the anode material 110 can include graphite. In some embodiments, the anode material 110 can be include a semi-solid graphite electrode material.

In some embodiments, the cathode material 130 can include semi-solid electrode materials, the same or substantially similar to those described in the '159 patent. In some embodiments, the cathode material 130 can include a conventional cathode material (e.g., a solid cathode). In some embodiments, the cathode material 130 can include an olivine-based electrode. In some embodiments, the anode material 110 can have a flat or substantially flat voltage profile near 100% state-of-charge (SOC). In some embodiments, the cathode material 130 can have a flat or substantially flat voltage profile near 100% SOC. In some embodiments, the use of a flat voltage layer on top of Lithium Nickel Manganese Cobalt Oxide (NMC) material can reduce overpotential of the NMC material.

In some embodiments, the cathode material 130 can have a porosity of less than about 3% or less than about 5%. In some embodiments, the cathode material 130 can have a porosity between about 20% and about 25%, between about 25% and about 30%, between about 30% and about 35%, between about 35% and about 40%, between about 40% and about 45%, between about 45% and about 50%, between about 50% and about 55%, or between about 55% and about 60%.

In some embodiments, the cathode 130 can be an NMC cathode. In some embodiments, the cathode 130 can be an NMC semi-solid cathode. In some embodiments, the cathode 130 can include a lithium manganese iron phosphate (LMFP) electrode. In some embodiments, the cathode material 130 can be a single layer of electrode material. In some embodiments, the cathode material 130 can include a semi-solid electrode material. In some embodiments, the cathode material 130 can include a conventional electrode material. In some embodiments, the cathode material 130 can include a solid electrode material. In some embodiments, the cathode material 130 can include NMC 811.

In some embodiments, the separator 150 can include polypropylene, polyethylene, a cellulosic-material, any other suitable polymeric material, or combinations thereof. In some embodiments, the separator 150 can be an ion-permeable membrane separator, the same or substantially similar to those described in U.S. Pat. No. 10,734,672 (“the '672 patent”), titled “Electrochemical Cells Including Selectively Permeable Membranes, Systems and Methods of Manufacturing the Same,” filed Jan. 8, 2019, the disclosure of which is hereby incorporated by reference in its entirety. In some embodiments, the separator 150 can be a conventional separator.

In some embodiments, the coating layer 160 can be disposed on the cathode material 130. In some embodiments, the coating layer 160 can be disposed on the anode material 110. In some embodiments, the coating layer 160 can be disposed on a side of the separator 150 adjacent to the anode material 110 (i.e., the anode side). In some embodiments, the coating layer 160 can be disposed on a side of the separator 150 adjacent to the cathode material 130 (i.e., the cathode side). In some embodiments, the coating layer 160 can be disposed on both the anode side and the cathode side of the separator 150. In other words, a first coating layer can be disposed on the anode side of the separator 150 and a second coating layer can be disposed on the cathode side of the separator 150. In some embodiments, the first coating layer can include hard carbon while the second coating layer includes Al₂O₃. In some embodiments, the coating layer 160 can include hard carbon, soft carbon, amorphous carbon, a graphitic hard carbon mixture, or any combination thereof. In some embodiments, hard carbon can expand less than graphite when lithium ions are intercalated into the hard carbon structure. In some embodiments, the hard carbon structure can include crystalline and amorphous portions, such that ions (e.g., Li+ ions) can intercalate into some portions of the hard carbon structure (i.e., a C6-Li structure) and be absorbed into other portions of the hard carbon structure (i.e., a C2-Li structure). In some embodiments, the coating layer 160 can include a swelling polymer. In some embodiments, the coating layer 160 can include a surfactant. In some embodiments, the coating layer 160 can include hard carbon that is well dispersed with a surfactant additive. In some embodiments, the surfactant can include a silicone-based surfactant, a hydrocarbon-based surfactant, lithium alginate, sodium alginate, or any combination thereof. In some embodiments, a solution containing the surfactant additive can be continuously printed via an inkjet. In some embodiments, the solution containing the surfactant additive can also include hard carbon. In some embodiments, the solution containing the surfactant additive and the hard carbon can be continuously printed via an inkjet. In some embodiments, the inkjet printing can be on a production line, such that the inkjet head is not clogged for more than a relatively short time period (e.g., not more than 5 hours, not more than 4 hours, not more than 3 hours, not more than 2 hours, not more than 1 hour, etc.). In some embodiments, the coating layer 160 can include an electrolyte solvent.

In some cases, a hard carbon coating in the coating layer 160 can be weakly bonded to the separator 150, such that a gentle tap can cause the hard carbon coating to fall off. In some cases, small particles of hard carbon can coat to the separator 150 while large particles of hard carbon fall off the separator 150. The incorporation of a binder into the coating layer 160 with the hard carbon coating can address this issue. In some embodiments, the coating layer 160 can include a binder. In some embodiments, the coating layer 160 can include a hard carbon coating and a binder. In some embodiments, the binder can include starch, carboxymethyl cellulose (CMC), diacetyl cellulose, hydroxypropyl cellulose, ethylene glycol, polyacrylates, poly(acrylic acid), polytetrafluoroethylene, polyimide, polyethylene-oxide, poly(vinylidene fluoride), rubbers, ethylene-propylene-diene monomer (EPDM), hydrophilic binders, polyvinylidene fluoride (PVDF), styrene butadiene copolymers, poly (3,4-ethylene dioxythiophene):poly (styrene sulfonate) (PEDOT:PSS), Poly(vinylidene fluoride-co-hexafluoropropylene) (PVDF-HFP), maleic anhydride-grated-polyvinylidene fluoride (MPVDF), styrene butadiene rubber (SBR), mixtures of SBR and sodium carboxymethyl cellulose (SBR+CMC), polyacrylonitrile, fluorinated polyimide, poly(3-hexylthiophene)-b-poly(ethylene oxide), poly (1-pyrenemethyl methacrylate) (PPy), poly (l-pyrenemethyl methacrylate-co-methacrylic acid) (PPy-MAA), poly (l-pyrenemethyl methacrylate-co-triethylene glycol methyl ether) (PPyE), polyacrylic acid and this lithium salt(PAA), sodium polyacrylate, fluorinated polyacrylate, polyimide (PI), polyamide imide (PAI), polyether imide (PEI), other suitable polymeric materials configured to provide sufficient mechanical support for the electrode materials, and combinations thereof.

In some embodiments, larger pores in the separator 150 can aid in preventing dendrite formation. In some embodiments, the separator 150 can include pores with pore sizes of at least about 50 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 1.1 μm, at least about 1.2 μm, at least about 1.3 μm, at least about 1.4 μm, at least about 1.5 μm, at least about 1.6 μm, at least about 1.7 μm, at least about 1.8 μm, or at least about 1.9 μm. In some embodiments, the separator 150 can include pores with pore sizes of no more than about 2 μm, no more than about 1.9 μm, no more than about 1.8 μm, no more than about 1.7 μm, no more than about 1.6 μm, no more than about 1.5 μm, no more than about 1.4 μm, no more than about 1.3 μm, no more than about 1.2 μm, no more than about 1.1 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, or no more than about 100 nm. Combinations of the above-referenced pore sizes in the separator 150 are also possible (e.g., at least about 50 nm and no more than about 2 μm or at least about 1 μm and no more than about 1.5 μm). In some embodiments, the separator 150 can include pores with pore sizes of about 50 nm, about 100 nm, about 200 nm, about 300 nm, about 400 nm, about 500 nm, about 600 nm, about 700 nm, about 800 nm, about 900 nm, about 1 μm, about 1.1 μm, about 1.2 μm, about 1.3 μm, about 1.4 μm, about 1.5 μm, about 1.6 μm, about 1.7 μm, about 1.8 μm, about 1.9 μm, or about 2 μm.

In some embodiments, the hard carbon can include a solid form of carbon that cannot be converted to graphite via heat treatment. In some embodiments, the hard carbon can include char. In some embodiments, the hard carbon can include charcoal. In some embodiments, the hard carbon can be produced by heating carbon-containing precursors in the absence of oxygen. In some embodiments, the precursors can include polyvinylidene chloride (PVDC), lignin, and/or sucrose.

In some embodiments, the coating layer 160 can include at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, at least about 70%, at least about 80%, at least about 90%, at least about 91%, at least about 92%, at least about 93%, at least about 94%, at least about 95%, at least about 96%, at least about 97%, at least about 98%, or at least about 99% hard carbon by volume. In some embodiments, the coating layer 160 can include no more than about 100%, no more than about 99%, no more than about 98%, no more than about 97%, no more than about 96%, no more than about 95%, no more than about 94%, no more than about 93%, no more than about 92%, no more than about 91%, no more than about 90%, no more than about 80%, no more than about 70%, no more than about 60%, no more than about 50%, no more than about 40%, no more than about 30%, no more than about 20%, no more than about 10%, no more than about 9%, no more than about 8%, no more than about 7%, no more than about 6%, no more than about 5%, no more than about 4%, no more than about 3%, no more than about 2%, no more than about 1%, no more than about 0.9%, no more than about 0.8%, no more than about 0.7%, no more than about 0.6%, no more than about 0.5%, no more than about 0.4%, no more than about 0.3%, or no more than about 0.2% by volume of hard carbon.

Combinations of the above-referenced volumetric percentages of hard carbon in the coating layer 160 are also possible (e.g., at least about 0.1% and no more than about 99% or at least about 40% and no more than about 80%), inclusive of all values and ranges therebetween. In some embodiments, the coating layer 160 can include about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 20%, about 30%, about 40%, about 50%, about 60%, about 70%, about 80%, about 90%, about 91%, about 92%, about 93%, about 94%, about 95%, about 96%, about 97%, about 98%, or about 99% hard carbon by volume.

In some embodiments, the coating layer 160 can reduce overpotential losses at an interface between the separator 150 and the cathode material 130 by at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90%. In some embodiments, the coating layer 160 can reduce overpotential losses at an interface between the separator 150 and the anode material 110 by at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90%.

In some embodiments, applying the coating layer 160 to the separator 150 can include mixing hard carbon with a binder and/or a coating solvent. In some embodiments, the hard carbon can be well coated to the separator 150 after the drying of the coating solvents. In some embodiments, the coating solvents can include electrolyte solvents. In some embodiments, the binder can include ethylene carbonate (EC). In some embodiments, the coating solvents can include dimethyl carbonate (DMC), ethyl methyl carbonate (EMC), or any combination thereof. In some embodiments, the hard carbon can first be mixed with EC, and then with a DMC/EMC mixture prior to applying to the separator 160. In some embodiments, the EC can be dissolved after assembly of the electrochemical cell 100.

In some embodiments, the coating layer 160 can include at least about 0.1%, at least about 0.2%, at least about 0.3%, at least about 0.4%, at least about 0.5%, at least about 0.6%, at least about 0.7%, at least about 0.8%, at least about 0.9%, at least about 1.0%, at least about 1.1%, at least about 1.2%, at least about 1.3%, at least about 1.4%, at least about 1.5%, at least about 1.6%, at least about 1.7%, at least about 1.8%, or at least about 1.9% by volume of binder when applied to the separator 150. In some embodiments, the coating layer 160 can include no more than about 2%, no more than about 1.9%, no more than about 1.8%, no more than about 1.7%, no more than about 1.6%, no more than about 1.5%, no more than about 1.4%, no more than about 1.3%, no more than about 1.2%, no more than about 1.1%, no more than about 1.0%, no more than about 0.9%, no more than about 0.8%, no more than about 0.7%, no more than about 0.6%, no more than about 0.5%, no more than about 0.4%, no more than about 0.3%, no more than about 0.2%, no more than about 0.1% by volume of binder when applied to the separator 150. Combinations of the above-referenced volume percentages of binder in the coating layer 160 when applied to the separator 150 are also possible (e.g., at least about 0.1% and no more than about 2% or at least about 0.5% and no more than about 1%), inclusive of all values and ranges therebetween. In some embodiments, the coating layer 160 can include about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, or about 2% by volume of binder when applied to the separator 150.

In some embodiments, the coating layer 160 can include active materials. In some embodiments, the coating layer 160 can include NMC. In some embodiments, the coating layer 160 can include lithium manganese iron phosphate (LMFP). In some embodiments, the coating layer 160 can include lithium iron phosphate (LFP). In some embodiments, the coating layer 160 can include lithium manganese oxide (LMO). In some embodiments, the coating layer 160 can include lithium nickel dioxide (LNO) doped with manganese. In some embodiments, including LMFP in the coating layer 160 can give way to a high voltage on a surface of an NMC electrode adjacent to the coating layer 160 and can prevent overpotential losses in the NMC material. In some embodiments, the coating layer 160 can act as a physical barrier to the movement of electroactive species. In some embodiments, the coating layer 160 can react chemically with electroactive species. In some embodiments, the coating layer 160 can act as an electrochemical storage medium. In some embodiments, the use of a semi-solid electrode material adjacent to the coating layer 160 can have reduced overpotential losses, as compared to the use of a conventional electrode material adjacent to the coating layer 160. Conventional electrode materials are often mixed with binders, dried and calendered. Binders can collect at the interface between the anode material 110 and the coating layer 160 and/or at the interface between the cathode material 130 and the coating layer 160. This can cause inefficiencies in ion transfer between the anode material 110 and the coating layer 160 and/or between the cathode material 130 and the coating layer 160.

In some embodiments, the coating layer 160 can include a higher voltage material than the electrode adjacent to the coating material 160, such that dendrite formation can be prevented. For example, if the coating layer 160 is disposed adjacent to the anode material 110 and the anode material 110 includes graphite, then the coating layer 160 can include a higher voltage material than graphite. Inclusion of a higher voltage material in the coating layer 160 can draw ions toward the coating layer 160 to prevent them from forming dendrites and potentially causing short circuit events. Using a semi-solid electrode material in the anode material 110 and/or the cathode material 130 (e.g., the semi-solid electrode materials described in the '159 patent) can prevent this buildup of binder material at the interface between the anode material 110 and the coating layer 160 or at the interface between the cathode material 130 and the coating layer 160. This reduced buildup can reduce overpotential losses in the electrochemical cell 100.

In some embodiments, when disposed on the anode side of the separator 150, the coating layer 160 can have a thickness of at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, or at least about 19 μm. In some embodiments, when disposed on the anode side of the separator 150, the coating layer 160 can have a thickness of no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, or no more than about 200 nm. Combinations of the above-referenced thicknesses of the coating layer 160 are also possible (e.g., at least about 100 nm and no more than about 20 μm or at least about 1 μm and no more than about 5 μm), inclusive of all values and ranges therebetween. In some embodiments, when disposed on the anode side of the separator 150, the coating layer 160 can have a thickness of at about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, or about 20 μm.

In some embodiments, when disposed on the cathode side of the separator 150, the coating layer 160 can have a thickness of at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 1.1 μm, at least about 1.2 μm, at least about 1.3 μm, at least about 1.4 μm, at least about 1.5 μm, at least about 1.6 μm, at least about 1.7 μm, at least about 1.8 μm, or at least about 1.9 μm. In some embodiments, when disposed on the cathode side of the separator 150, the coating layer 160 can have a thickness of no more than about 2 μm, no more than about 1.9 μm, no more than about 1.8 μm, no more than about 1.7 μm, no more than about 1.6 μm, no more than about 1.5 μm, no more than about 1.4 μm, no more than about 1.3 μm, no more than about 1.2 μm, no more than about 1.1 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, or no more than about 20 nm. Combinations of the above-referenced thicknesses of the coating layer 160 are also possible (e.g., at least about 10 nm and no more than about 2 μm or at least about 200 nm and no more than about 1.5 μm), inclusive of all values and ranges therebetween. In some embodiments, when disposed on the cathode side of the separator 150, the coating layer 160 can have a thickness of about 10 nm, at about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 1.1 μm, about 1.2 μm, about 1.3 μm, about 1.4 μm, about 1.5 μm, about 1.6 μm, about 1.7 μm, about 1.8 μm, about 1.9 μm, or about 2 μm.

In some embodiments, the coating layer 160 can have a density of at least about 1.2 g/cc, at least about 1.3 g/cc, at least about 1.4 g/cc, at least about 1.5 g/cc, at least about 1.6 g/cc, at least about 1.7 g/cc, at least about 1.8 g/cc, or at least about 1.9 g/cc. In some embodiments, the coating layer 160 can have a density of no more than about 2 g/cc, no more than about 1.9 g/cc, no more than about 1.8 g/cc, no more than about 1.7 g/cc, no more than about 1.6 g/cc, no more than about 1.5 g/cc, no more than about 1.4 g/cc, or no more than about 1.3 g/cc. Combinations of the above-referenced densities of the coating layer 160 are also possible (e.g., at least about 1.2 g/cc and no more than about 2 g/cc or at least about 1.3 g/cc and no more than about 2 g/cc), inclusive of all values and ranges therebetween. In some embodiments, the coating layer 160 can have a density of about 1.2 g/cc, about 1.3 g/cc, about 1.4 g/cc, about 1.5 g/cc, about 1.6 g/cc, about 1.7 g/cc, about 1.8 g/cc, about 1.9 g/cc, or about 2 g/cc.

In some embodiments, the coating layer 160 can include particles with an average particle size (i.e., D50) of at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 200 nm, at least about 300 nm, at least about 400 nm, at least about 500 nm, at least about 600 nm, at least about 700 nm, at least about 800 nm, at least about 900 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, or at least about 19 μm. In some embodiments, the coating layer 160 can include particles with an average particle size of no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, no more than about 600 nm, no more than about 500 nm, no more than about 400 nm, no more than about 300 nm, no more than about 200 nm, no more than about 100 nm, no more than about 90 nm, no more than about 80 nm, no more than about 70 nm, no more than about 60 nm, no more than about 50 nm, no more than about 40 nm, no more than about 30 nm, or no more than about 20 nm.

Combinations of the above-referenced particle sizes are also possible (e.g., at least about 10 nm and no more than about 20 μm or at least about 1 μm and no more than about 5 μm), inclusive of all values and ranges therebetween. In some embodiments, the coating layer 160 can include particles with an average particle size of about 10 nm, about 20 nm, about 30 nm, about 40 nm, about 50 nm, about 60 nm, about 70 nm, about 80 nm, about 90 nm, about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, or about 19 μm, or about 20 μm.

In some embodiments, the coating layer 160 can have a particle loading density of at least about 20 vol %, at least about 25 vol %, at least about 30 vol %, at least about 35 vol %, at least about 40 vol %, at least about 45 vol %, at least about 50 vol %, at least about 55 vol %, at least about 60 vol %, at least about 65 vol %, at least about 70 vol %, at least about 75 vol %, at least about 80 vol %, or at least about 85 vol %. In some embodiments, the coating layer 160 can have a particle loading density of no more than about 90 vol %, no more than about 85 vol %, no more than about 80 vol %, no more than about 75 vol %, no more than about 70 vol %, no more than about 65 vol %, no more than about 60 vol %, no more than about 55 vol %, no more than about 50 vol %, no more than about 45 vol %, no more than about 40 vol %, no more than about 35 vol %, no more than about 30 vol %, or no more than about 25 vol %. Combinations of the above-referenced particle loading densities are also possible (e.g., at least about 20 vol % and no more than about 90 vol % or at least about 30 vol % and no more than about 60 vol %), inclusive of all values and ranges therebetween. In some embodiments, the coating layer 160 can have a particle loading density of about 20 vol %, about 25 vol %, about 30 vol %, about 35 vol %, about 40 vol %, about 45 vol %, about 50 vol %, about 55 vol %, about 60 vol %, about 65 vol %, about 70 vol %, about 75 vol %, about 80 vol %, about 85 vol %, or about 90 vol %.

In some embodiments, the coating layer 160 can be applied to the separator 150 via a vapor deposition process, chemical vapor deposition, physical vapor deposition, atomic layer deposition, metal-organic chemical vapor deposition, nitrogen-plasma assisted deposition, sputter deposition, reactive sputter deposition, spattering, melt quenching, mechanical milling, spraying, a cold spray process, a plasma deposition process, electrochemical deposition, a sol-gel process, or any combination thereof. In some embodiments, the coating layer 160 can be applied to the separator 150 via a liquid coating process, an extrusion process with or without a hot/cold press process. In some embodiments, the coating layer 160 can be applied to the separator via casting, calendering, drop coating, pressing, roll pressing, tape casting, or any combination thereof. In some embodiments, the coating layer 160 can be applied to the separator 150 via any of the methods described in the '351 publication and/or the '672 patent.

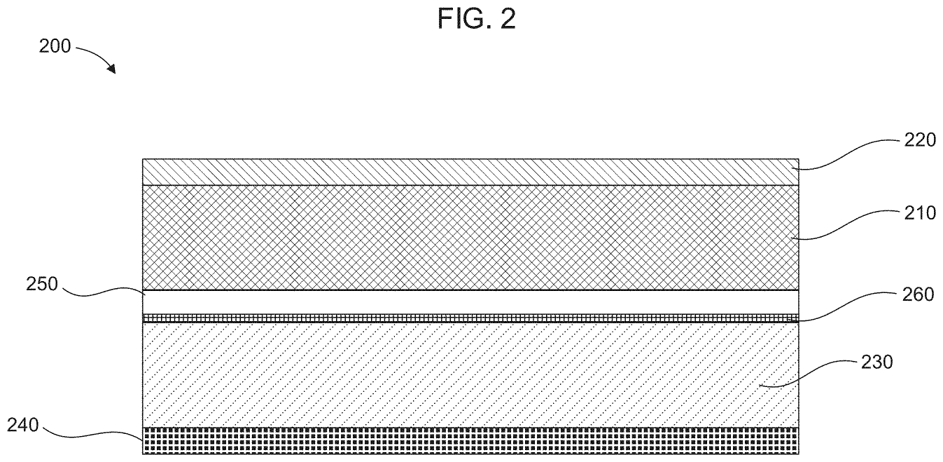

FIG. 2 is a schematic illustration of an electrochemical cell 200, according to an embodiment. As shown, the electrochemical cell 200 includes an anode material 210 disposed on an anode current collector 220, a cathode material 230 disposed on a cathode current collector 240 and a separator 250 disposed between the anode material 210 and the cathode material 230. As shown, a coating layer 260 is disposed between the cathode material 230 and the separator 250.

In some embodiments, the anode material 210, the anode current collector 220, the cathode material 230, the cathode current collector 240, the separator 250, and the coating layer 260 can be the same or substantially similar to the anode 110, the anode current collector 120, the cathode material 130, the cathode current collector 140, the separator 150, and the coating layer 160. Thus, certain aspects of the anode material 210, the anode current collector 220, the cathode material 230, the cathode current collector 240, the separator 250, and the coating layer 260 are not described in greater detail herein.

In some embodiments, the coating layer 260 can include one or more materials that inhibit formation and/or growth of dendrites in the cathode material 230. In some embodiments, the coating layer 260 can include hard carbon, soft carbon, amorphous carbon, a graphitic hard carbon mixture, or any combination thereof. In some embodiments, the coating layer 260 can be selected to inhibit formation and/or growth of dendrites on a semi-solid cathode. In some embodiments, the coating layer 260 can be disposed on the separator 250. In some embodiments, the coating layer 260 can be disposed on the anode material 230.

In some embodiments, the cathode material 230 can have a first thickness and the coating layer 260 can have a second thickness. In some embodiments, the ratio of the thickness of the cathode material 230 to the coating layer 260 can be at least about 1:1, at least about 2:1, at least about 3:1, at least about 4:1, at least about 5:1, at least about 6:1, at least about 7:1, at least about 8:1, at least about 9:1, at least about 10:1, at least about 20:1, at least about 30:1, at least about 40:1, at least about 50:1, at least about 60:1, at least about 70:1, at least about 80:1, at least about 90:1, at least about 100:1, at least about 200:1, at least about 300:1, at least about 400:1, at least about 500:1, at least about 600:1, at least about 700:1, at least about 800:1, or at least about 900:1. In some embodiments, the ratio of the thickness of the cathode material 230 to the coating layer 260 can be no more than about 1,000:1, no more than about 900:1, no more than about 800:1, no more than about 700:1, no more than about 600:1, no more than about 500:1, no more than about 400:1, no more than about 300:1, no more than about 200:1, no more than about 100:1, no more than about 90:1, no more than about 80:1, no more than about 70:1, no more than about 60:1, no more than about 50:1, no more than about 40:1, no more than about 30:1, no more than about 20:1, no more than about 10:1, no more than about 9:1, no more than about 8:1, no more than about 7:1, no more than about 6:1, no more than about 5:1, no more than about 4:1, no more than about 3:1, or no more than about 2:1.

Combinations of the above-referenced ratios of the thickness of cathode material 230 to the coating layer 260 are also possible (e.g., at least about 1:1 and no more than about 1,000:1 or at least about 10:1 and no more than about 100:1), inclusive of all values and ranges therebetween. In some embodiments, the ratio of the thickness of the cathode material 230 to the coating layer 260 can be about 1:1, about 2:1, about 3:1, about 4:1, about 5:1, about 6:1, about 7:1, about 8:1, about 9:1, about 10:1, about 20:1, about 30:1, about 40:1, about 50:1, about 60:1, about 70:1, about 80:1, about 90:1, about 100:1, about 200:1, about 300:1, about 400:1, about 500:1, about 600:1, about 700:1, about 800:1, about 900:1, or about 1,000:1.

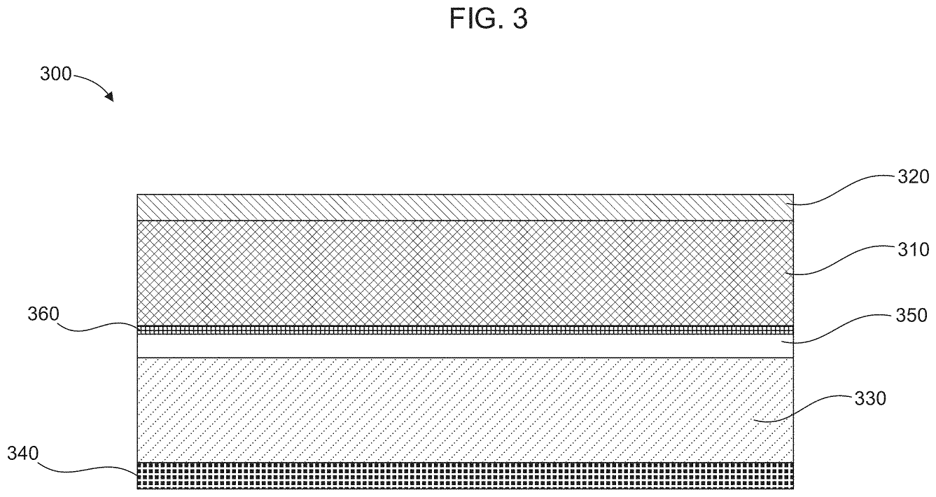

FIG. 3 is a schematic illustration of an electrochemical cell 300, according to an embodiment. As shown, the electrochemical cell 300 includes an anode material 310 disposed on an anode current collector 320, a cathode material 330 disposed on a cathode current collector 340 and a separator 350 disposed between the anode material 310 and the cathode material 330. As shown, a coating layer 360 is disposed between the anode material 310 and the separator 350.

In some embodiments, the anode material 310, the anode current collector 320, the cathode material 330, the cathode current collector 340, the separator 350, and the coating layer 360 can be the same or substantially similar to the anode 110, the anode current collector 120, the cathode material 130, the cathode current collector 140, the separator 150, and the coating layer 160. Thus, certain aspects of the anode material 310, the anode current collector 320, the cathode material 330, the cathode current collector 340, the separator 350, and the coating layer 360 are not described in greater detail herein.

In some embodiments, the coating layer 360 can include one or more materials that inhibit formation and/or growth of dendrites in the anode material 310. In some embodiments, the coating layer 360 can include Al₂O₃. In some embodiments, the coating layer 360 can include boehmite. In some embodiments, the coating layer 360 can include hard carbon. In some embodiments, the coating layer 360 can be selected to inhibit formation and/or growth of dendrites on a semi-solid anode. In some embodiments, the coating layer 360 can be disposed on the separator 350. In some embodiments, the coating layer 360 can be disposed on the anode material 310. In some embodiments, the coating layer 360 can include an alloy anode material. In some embodiments, the coating layer 360 can include silicon, indium, tin, or any combination thereof. In some embodiments, the coating layer 360 can include carbon paper. In some embodiments, the coating layer 360 can include conductive carbon mixed with electrolyte (e.g., Ketjen carbon mixed with electrolyte) as a buffer region for lithium to grow. In other words, the coating layer 360 can act as a lithium host.

In some embodiments, the anode material 310 can have a first thickness and the coating layer 360 can have a second thickness. In some embodiments, the ratio of the thickness of the anode material 310 to the coating layer 360 can be at least about 1:1, at least about 2:1, at least about 3:1, at least about 4:1, at least about 5:1, at least about 6:1, at least about 7:1, at least about 8:1, at least about 9:1, at least about 10:1, at least about 20:1, at least about 30:1, at least about 40:1, at least about 50:1, at least about 60:1, at least about 70:1, at least about 80:1, at least about 90:1, at least about 100:1, at least about 200:1, at least about 300:1, at least about 400:1, at least about 500:1, at least about 600:1, at least about 700:1, at least about 800:1, or at least about 900:1. In some embodiments, the ratio of the thickness of the anode material 310 to the coating layer 360 can be no more than about 1,000:1, no more than about 900:1, no more than about 800:1, no more than about 700:1, no more than about 600:1, no more than about 500:1, no more than about 400:1, no more than about 300:1, no more than about 200:1, no more than about 100:1, no more than about 90:1, no more than about 80:1, no more than about 70:1, no more than about 60:1, no more than about 50:1, no more than about 40:1, no more than about 30:1, no more than about 20:1, no more than about 10:1, no more than about 9:1, no more than about 8:1, no more than about 7:1, no more than about 6:1, no more than about 5:1, no more than about 4:1, no more than about 3:1, or no more than about 2:1.

Combinations of the above-referenced ratios of the thickness of anode material 310 to the coating layer 360 are also possible (e.g., at least about 1:1 and no more than about 1,000:1 or at least about 10:1 and no more than about 100:1), inclusive of all values and ranges therebetween. In some embodiments, the ratio of the thickness of the anode material 310 to the coating layer 360 can be about 1:1, about 2:1, about 3:1, about 4:1, about 5:1, about 6:1, about 7:1, about 8:1, about 9:1, about 10:1, about 20:1, about 30:1, about 40:1, about 50:1, about 60:1, about 70:1, about 80:1, about 90:1, about 100:1, about 200:1, about 300:1, about 400:1, about 500:1, about 600:1, about 700:1, about 800:1, about 900:1, or about 1,000:1.

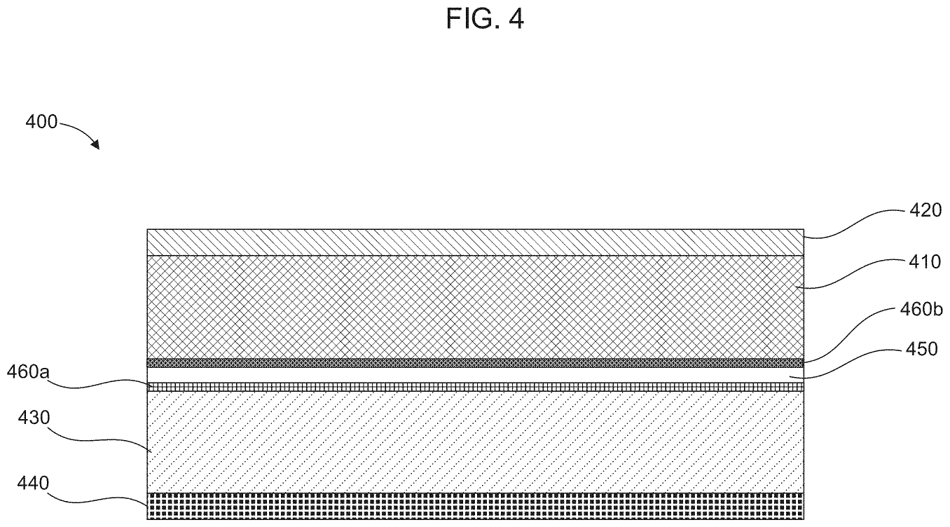

FIG. 4 is a schematic illustration of an electrochemical cell 400, according to an embodiment. As shown, the electrochemical cell 400 includes an anode material 410 disposed on an anode current collector 420, a cathode material 430 disposed on a cathode current collector 440 and a separator 450 disposed between the anode material 410 and the cathode material 430. As shown, a first coating layer 460a is disposed between the cathode material 430 and the separator 450, while a second coating layer 460b is disposed between the anode material 410 and the separator 450.

In some embodiments, the anode material 410, the anode current collector 420, the cathode material 430, the cathode current collector 440, and the separator 450 can have the same or substantially similar properties to the anode material 110, the anode current collector 120, the cathode material 130, the cathode current collector 140, and the separator 150, as described above with reference to FIG. 1. In some embodiments, the first coating layer 460a can have the same or substantially similar properties to the coating layer 260, as described above with reference to FIG. 2. In some embodiments, the second coating layer 460b can have the same or substantially similar properties to the coating layer 360, as described above with reference to FIG. 3. Thus, certain aspects of the anode material 410, the anode current collector 420, the cathode material 430, the cathode current collector 440, the separator 450, the first coating layer 460a, and the second coating layer 460b are not described in greater detail herein.

Incorporating the first coating layer 460a on the anode side of the electrochemical cell 400 and the second coating layer 460b on the cathode side of the electrochemical cell 400 can aid in preventing dendrite formation and growth on both the anode material 410 and the cathode material 430. In some embodiments, the materials of the first coating layer 460a and the second coating layer 460b can be selected based on their compatibility with the chemistry of the electrochemical cell 400. In some embodiments, the first coating layer 460a can be composed of the same or substantially similar material to the second coating layer 460b. In some embodiments, the first coating layer 460a can be composed of a first material and the second coating layer 460b can be composed of a second material, the second material different from the first material. In some embodiments, the first coating layer 460a can include hard carbon and the second coating layer 460b can include Al₂O₃.

In some embodiments, the first coating layer 460a and the second coating layer 460b can have the same or substantially similar thicknesses. In some embodiments, the first coating layer 460a can have a first thickness and the second coating layer 460b can have a second thickness, the second thickness different from the first thickness. In some embodiments, the first coating layer 460a can be thicker than the second coating layer 460b. In some embodiments, the second coating layer 460b can be thicker than the first coating layer 460a. In some embodiments, the ratio of the thickness of the first coating layer 460a to the thickness of the second coating layer 460b can be at least about 1:50, at least about 1:40, at least about 1:30, at least about 1:20, at least about 1:10, at least about 1:5, at least about 1:4, at least about 1:3, at least about 1:2, at least about 1:1.9, at least about 1:1.8, at least about 1:1.7, at least about 1:1.6, at least about 1:1.5, at least about 1:1.4, at least about 1:1.3, at least about 1:1.2, at least about 1:1.1, at least about 1:1, at least about 1.1:1, at least about 1.2:1, at least about 1.3:1, at least about 1.4:1, at least about 1.5:1, at least about 1.6:1, at least about 1.7:1, at least about 1.8:1, at least about 1.9:1, at least about 2:1, at least about 3:1, at least about 4:1, at least about 5:1, at least about 6:1, at least about 7:1, at least about 8:1, at least about 9:1, at least about 10:1, at least about 20:1, at least about 30:1, at least about 40:1, at least about 50:1, at least about 60:1, at least about 70:1, at least about 80:1, or at least about 90:1. In some embodiments, the ratio of the thickness of the first coating layer 460a to the thickness of the second coating layer 460b can be no more than about 100:1, no more than about 90:1, no more than about 80:1, no more than about 70:1, no more than about 60:1, no more than about 50:1, no more than about 40:1, no more than about 30:1, no more than about 20:1, no more than about 10:1, no more than about 9:1, no more than about 8:1, no more than about 7:1, no more than about 6:1, no more than about 5:1, no more than about 4:1, no more than about 3:1, no more than about 2:1, no more than about 1.9:1, no more than about 1.8:1, no more than about 1.7:1, no more than about 1.6:1, no more than about 1.5:1, no more than about 1.4:1, no more than about 1.3:1, no more than about 1.2:1, no more than about 1.1:1, no more than about 1:1, no more than about 1:1.1, no more than about 1:1.2, no more than about 1:1.3, no more than about 1:1.4, no more than about 1:1.5, no more than about 1:1.6, no more than about 1:1.7, no more than about 1:1.8, no more than about 1:1.9, no more than about 1:2, no more than about 1:3, no more than about 1:4, no more than about 1:5, no more than about 1:6, no more than about 1:7, no more than about 1:8, no more than about 1:9, no more than about 1:10, no more than about 1:20, no more than about 1:30, or no more than about 1:40.

Combinations of the above-referenced ratios of the thickness of the first coating layer 460a to the thickness of the second coating layer 460b are also possible (e.g., at least about 1:50 and no more than about 100:1 or at least about 1:1 and no more than about 10:1, inclusive of all values and ranges therebetween. In some embodiments, the ratio of the thickness of the first coating layer 460a to the thickness of the second coating layer 460b can be about 1:50, about 1:40, about 1:30, about 1:20, about 1:10, about 1:5, about 1:4, about 1:3, about 1:2, about 1:1.9, about 1:1.8, about 1:1.7, about 1:1.6, about 1:1.5, about 1:1.4, about 1:1.3, about 1:1.2, about 1:1.1, about 1:1, about 1.1:1, about 1.2:1, about 1.3:1, about 1.4:1, about 1.5:1, about 1.6:1, about 1.7:1, about 1.8:1, about 1.9:1, about 2:1, about 3:1, about 4:1, about 5:1, about 6:1, about 7:1, about 8:1, about 9:1, about 10:1, about 20:1, about 30:1, about 40:1, about 50:1, about 60:1, about 70:1, about 80:1, about 90:1, or about 100:1.

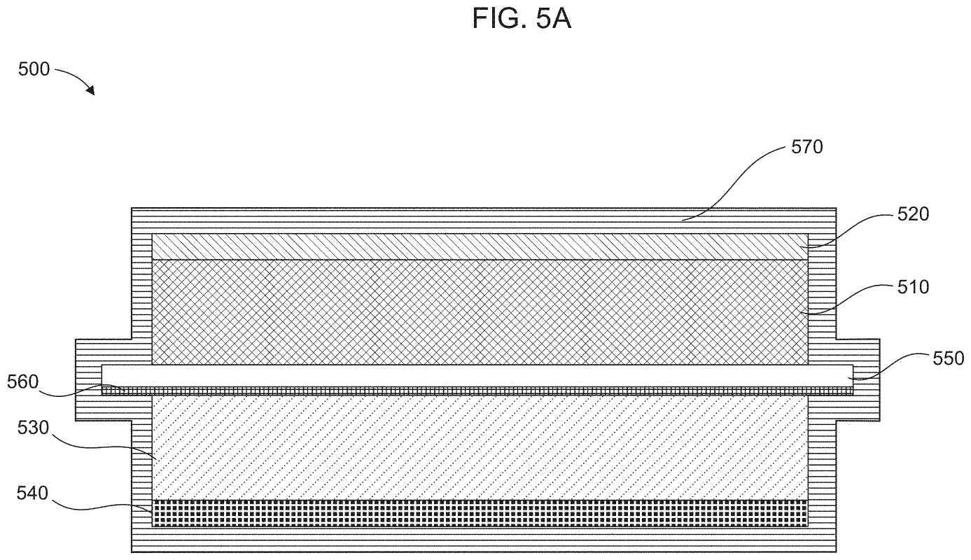

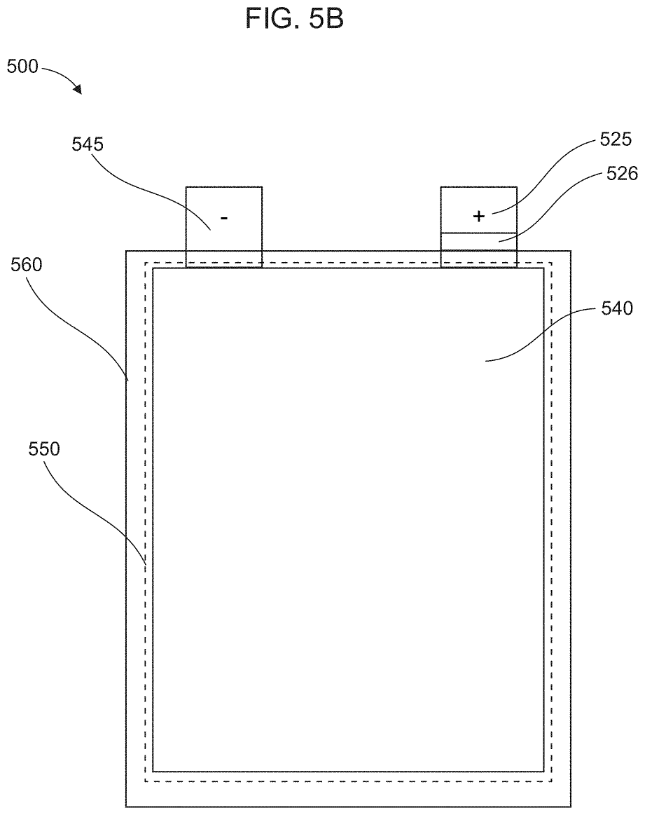

FIGS. 5A-5B are schematic illustrations of an electrochemical cell 500, according to an embodiment. FIG. 5A includes a cross-sectional view of the electrochemical cell 500, while FIG. 5B includes a top view of the electrochemical cell 500. The electrochemical cell 500 includes an anode material 510 disposed on an anode current collector 520, a cathode material 530 disposed on a cathode current collector 540 and a separator 550 disposed between the anode material 510 and the cathode material 530. A coating layer 560 is disposed between the cathode material 530 and the separator 550. The anode material 510, the anode current collector 520, the cathode material 530, the cathode current collector 540, the separator 550, and the coating layer 560 are disposed in a pouch 570. The anode current collector 520 includes an anode tab 525. The cathode current collector 540 includes a cathode tab 545.

In some embodiments, the anode material 510, the anode current collector 520, the cathode material 530, the cathode current collector 540, the separator 550, and the coating layer 560 can be the same or substantially similar to the anode 110, the anode current collector 120, the cathode 130, the cathode current collector 140, the separator 150, and the coating layer 160. Thus, certain aspects of the anode material 510, the anode current collector 520, the cathode material 530, the cathode current collector 540, the separator 550, and the coating layer 560 are not described in greater detail herein.

In some embodiments, the separator 550 can extend beyond the edges of the anode material 510 and the cathode material 530. In some embodiments, the coating layer 560 can be disposed on portions of the separator 550 that extend beyond the edges of the anode material 510 and the cathode material 530. In some embodiments, the portions of the separator 550 that extend beyond the anode material 510 and the cathode material 530 can be sealed to portions of the pouch 570. Sealing portions of the separator 550 to portions of the pouch 570 can help prevent the coating layer 560 from making contact with the cathode material 530 or with cathodes from adjacent electrochemical cells. In some embodiments, if the coating layer 560 is disposed on the cathode side of the separator 550, sealing portions of the separator 550 to portions of the pouch 570 can help prevent the coating layer 560 from making contact with the anode material 510 or with anodes from adjacent electrochemical cells. This isolation and contact prevention can aid in preventing short circuit events. The isolation and contact prevention can be particularly useful when an electrochemical cell is rolled up and disposed into a can, as contact between the coating layer 560 and the walls of a can may result in a short circuit event. Further examples of electrochemical cells, in which edges of the separator are sealed to a pouch are further described in U.S. Pat. No. 9,178,200, (the '200 patent), entitled “Electrochemical Cells and Methods of Manufacturing the Same,” the disclosure of which is hereby incorporated by reference in its entirety. Further examples of single electrochemical cells disposed in pouches are further described in U.S. Pat. No. 10,181,587 (the '587 patent), entitled “Single Pouch Battery Cells and Methods of Manufacture,” the disclosure of which is hereby incorporated by reference in its entirety.

In order to further limit or prevent contact between the coating layer 560 and electroactive material from other electrochemical cells, an insulation 526 is shown between the anode tab 525 and the pouch 570. The insulation 526 further isolates the coating layer 560 from contact with electroactive species, further preventing short circuit events. In some embodiments, the insulation 526 can be disposed around a perimeter of the anode tab 525, creating a seal between the anode tab 525 and the pouch 570. In some embodiments, the insulation 526 can include an adhesive, a seal, a heat seal, or any other suitable means of insulation. In some embodiments, an insulation can exist between the cathode tab 545 and the pouch 570. In some embodiments, a first insulation can exist between the anode tab 525 and the pouch 570 and a second insulation can exist between the cathode tab 545 and the pouch 570.

In some embodiments, the anode material 510 can include a semi-solid electrode material. In some embodiments, the anode 510 can include a conventional electrode material. In some embodiments, the anode material 510 can be a solid electrode. In some embodiments, the anode material 510 can include a graphite electrode material. In some embodiments, the anode material 510 can include a semi-solid graphite electrode material.

In some embodiments, the cathode material 530 can include a semi-solid electrode material. In some embodiments, the cathode material 530 can include a conventional electrode material. In some embodiments, the cathode material 530 can include a solid electrode material. In some embodiments, the cathode material 530 can include NMC 811.

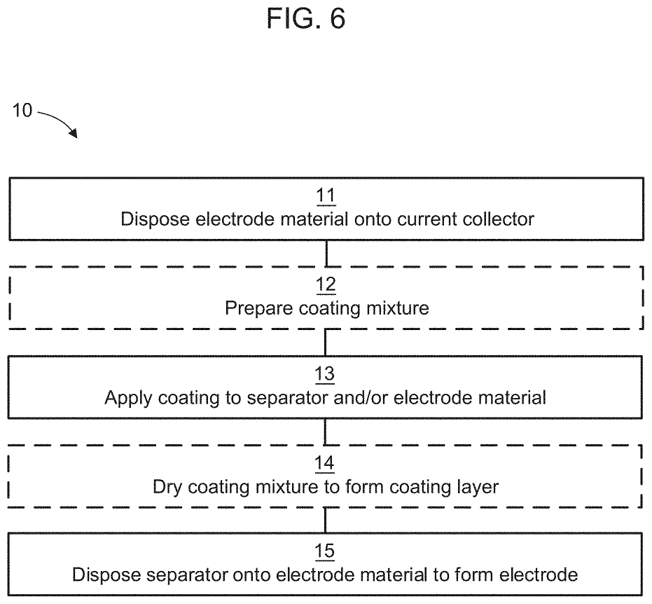

FIG. 6 is a block diagram of a method 10 of forming an electrode with a coating layer, according to an embodiment. As shown, the method 10 includes disposing an electrode material onto a current collector at step 11. The method 10 optionally includes preparing a coating mixture at step 12. The method 10 further includes applying a coating to a separator and/or the electrode material at step 13. The method 10 optionally includes drying the coating mixture form the coating layer at step 14. The method 10 then includes disposing the separator onto the electrode material to form an electrode at step 15.

At step 11, the electrode material is disposed onto the current collector. In some embodiments, the electrode material can be an anode material. In some embodiments, the electrode material can be a cathode material. In some embodiments, the electrode material can include a semi-solid electrode material. In some embodiments, the electrode material can include a conventional electrode material. In some embodiments, the electrode material can include a solid electrode material. In some embodiments, the electrode material can be extruded onto the current collector. In some embodiments, the electrode material can be disposed using any of the methods described in U.S. patent publication no. 2020/0014025 (“the '025 publication), filed Jul. 9, 2019, titled “Continuous and Semi-Continuous Methods of Semi-Solid Electrode and Battery Manufacturing,” the disclosure of which is hereby incorporated by reference in its entirety.

Optional step 12 includes preparing the coating mixture. In some embodiments, step 12 includes mixing a coating material (e.g., any of the materials in the coating material 160 as described above with reference to FIG. 1) with a solvent. In some embodiments, the solvent can include an electrolyte solvent. In some embodiments, the solvent can include ethylene carbonate (EC), propylene carbonate (PC), ethyl methyl carbonate (EMC), dimethyl carbonate (DMC), diethyl carbonate (DEC), γ-butyrolactone (GBL), or any combination thereof. In some embodiments, inclusion of an electrolyte solvent can improve thermal stability of the resulting electrode or electrochemical cell. In some embodiments, inclusion of an electrolyte solvent in the coating layer can promote the wetting of the coating layer to the separator and/or the adjacent electrode, reducing internal cell resistance. In some embodiments, inclusion of an electrolyte solvent in the coating layer can prevent electrolyte salt buildup and corrosion of electrodes via electrolyte salt (e.g., LiPF₆). In some embodiments, inclusion of an electrolyte solvent in the coating layer can prevent drying of an electrode beneath the coating layer (e.g., from electrolyte evaporation).

In some embodiments, the coating mixture can include a binder. In some embodiments, the binder can include In some embodiments, the binder can include starch, carboxymethyl cellulose (CMC), diacetyl cellulose, hydroxypropyl cellulose, ethylene glycol, polyacrylates, poly(acrylic acid), polytetrafluoroethylene, polyimide, polyethylene-oxide, poly(vinylidene fluoride), rubbers, ethylene-propylene-diene monomer (EPDM), hydrophilic binders, polyvinylidene fluoride (PVDF), styrene butadiene copolymers, poly (3,4-ethylene dioxythiophene):poly (styrene sulfonate) (PEDOT:PSS), Poly(vinylidene fluoride-co-hexafluoropropylene) (PVDF-HFP), maleic anhydride-grated-polyvinylidene fluoride (MPVDF), styrene butadiene rubber (SBR), mixtures of SBR and sodium carboxymethyl cellulose (SBR+CMC), polyacrylonitrile, fluorinated polyimide, poly(3-hexylthiophene)-b-poly(ethylene oxide), poly (1-pyrenemethyl methacrylate) (PPy), poly (l-pyrenemethyl methacrylate-co-methacrylic acid) (PPy-MAA), poly (l-pyrenemethyl methacrylate-co-triethylene glycol methyl ether) (PPyE), polyacrylic acid and this lithium salt (PAA), sodium polyacrylate, fluorinated polyacrylate, polyimide (PI), polyamide imide (PAI), polyether imide (PEI), and or any combination thereof. In some embodiments, the binder can be dissolved in a binder solvent. In some embodiments, the binder solvent can include DMC, EMC, or any combination thereof. In some embodiments, the coating material can include an electrolyte solvent and a binder solvent.

In some embodiments, the preparation of the coating mixture can include a mixing process. In some embodiments, the mixing process can include a high-shear mixing process. In some embodiments, the mixing process can include twin-screw extrusion. In some embodiments, the mixing process can include batch mixing. In some embodiments, the mixing process can include planetary mixing, centrifugal planetary mixing, sigma mixing, and/or roller mixing. In some embodiments, the preparation of the coating mixture can include continuous inkjet printing. In some embodiments, a solution with a surfactant additive can be continuously printed via an inkjet (e.g., on a production line). In some embodiments, the implementation of the inkjet on a production line can prevent clogging of the inkjet for more than a relatively short time period (e.g., not more than 5 hours, not more than 4 hours, not more than 3 hours, not more than 2 hours, no more than 1 hour, etc.). In some embodiments, the solution with the surfactant additive can be mixed with hard carbon to form the coating mixture.

In some embodiments, the solution with the surfactant additive can be mixed with hard carbon prior to printing. In other words, a mixture including the surfactant additive and the hard carbon can be stabilized and fed into the inkjet as the inkjet solution. From the inkjet, the inkjet solution can be printed directly onto the separator and/or the electrode material. The surfactant can promote wetting capabilities of the coating. The surfactant can also reduce flammability of the coating. The surfactant can also promote adhesion of the coating mixture onto the separator and/or the electrode material.

In some embodiments, the coating mixture can include EC, PC, a surfactant, and hard carbon. In some embodiments, the coating mixture can include about 5%, about 10%, about 15%, about 20%, about 25%, about 30%, about 35%, or about 40% hard carbon by volume, inclusive of all values and ranges therebetween.

Step 13 includes applying the coating to the separator and/or the electrode material. In some embodiments, the coating can be applied to the separator. In some embodiments, the coating can be applied to the cathode material. In some embodiments, the coating can be applied to the anode material. In some embodiments, the coating can be a coating mixture (e.g., as prepared in step 12). In some embodiments, the coating can be a single material (e.g., hard carbon, amorphous carbon, soft carbon). In some embodiments, the coating can be applied to the separator. In some embodiments, the coating can be applied to the electrode material. In some embodiments, the coating can be applied to both the separator and the electrode material. In some embodiments, applying the coating mixture can be via a vapor deposition process, chemical vapor deposition, physical vapor deposition, atomic layer deposition, metal-organic chemical vapor deposition, nitrogen-plasma assisted deposition, sputter deposition, reactive sputter deposition, spattering, melt quenching, mechanical milling, spraying, a cold spray process, a plasma deposition process, electrochemical deposition, a sol-gel process, casting, calendering, drop coating, pressing, roll pressing, tape casting, a liquid coating process, an extrusion process with or without a hot/cold press process, or any combination thereof. In some embodiments, electrolyte solvent (e.g., the electrolyte solvents described above with reference to step 12) can be added to the coating after the coating is applied to the separator and/or the electrode material. In some embodiments, the electrolyte solvent can be sprayed onto the coating. In some embodiments, the coating can be applied or printed from an inkjet printer.

Optional step 14 includes drying the coating mixture to form the coating layer. If the coating applied to the separator and/or the electrode material at step 13 includes liquids (e.g., liquid electrolytes), the coating can be dried at step 14. In some embodiments, the drying at step 14 can include a heat-drying process. In some embodiments, the drying can include an absorption and/or an adsorption process to draw liquid away from the coating. In some embodiments, the drying can include vacuum drying. In some embodiments, the drying can induce a chemical change in the coating. In some embodiments, the coating can cure during the drying process.

Step 15 includes disposing the separator onto the electrode material to form an electrode. In some embodiments, the separator can have a coating layer disposed thereon. In some embodiments, the electrode material can have a coating layer disposed thereon. In some embodiments, the electrode can be a first electrode, and a second electrode can be disposed on the first electrode to form an electrochemical cell.

### EXAMPLES

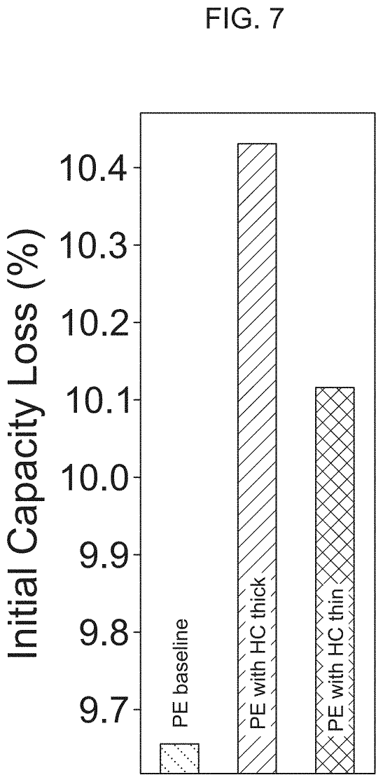

FIG. 7 is a graphical representation of initial capacity loss in different electrochemical cell configurations. The cells evaluated in this case include a cathode with NMC 811 and a semi-solid graphite anode. As compared to baseline cases with conventional separators without coating, cells that include polyethylene separators spray coated with thick coating (i.e., about 10 μm) and thin coating (i.e., less than 5 μm) of hard carbon on the anode side have an increase in initial capacity loss of about 0.5% to about 0.7%, depending on thickness. This is due to a larger volume and surface area of territory, in which a solid-electrolyte interface (SEI) layer is forming. Pre-lithiation of the anode can potentially reduce or mitigate this initial capacity loss.

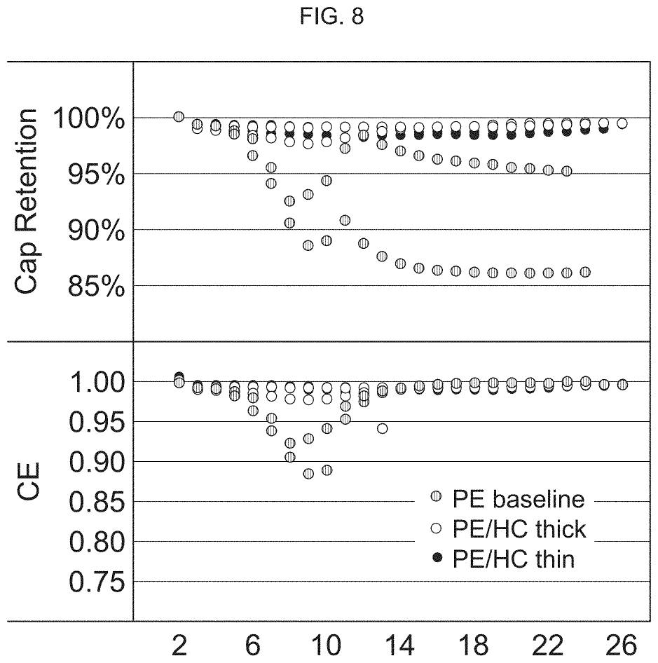

FIG. 8 is a graphical representation of capacity retention vs. number of cycles in different electrochemical cell configurations. Similar to FIG. 7, FIG. 8 includes an electrochemical cell with an NMC 811 cathode, a semi-solid graphite anode, and a conventional polyethylene separator compared to electrochemical cells with an NMC 811 cathode, a semi-solid graphite anode and polyethylene separators coated with a thin coating (i.e., less than 5 μm) and a thick coating (i.e., about 10 μm) of hard carbon on the anode side. The top plot shows the baseline case having an initial decline in capacity during the first few cycles and then a recovery, before a fast fading of capacity. The polyethylene separators with hard carbon coating have an initial slight capacity loss, and then recover, maintaining about 98%-99% capacity through 26 cycles. The bottom plot shows an initial decline in coulombic efficiency of the baseline case and recovery around the 12^{th} cycle. The bottom plot also shows the cells with hard carbon coating on the separator maintaining high coulombic efficiency throughout.

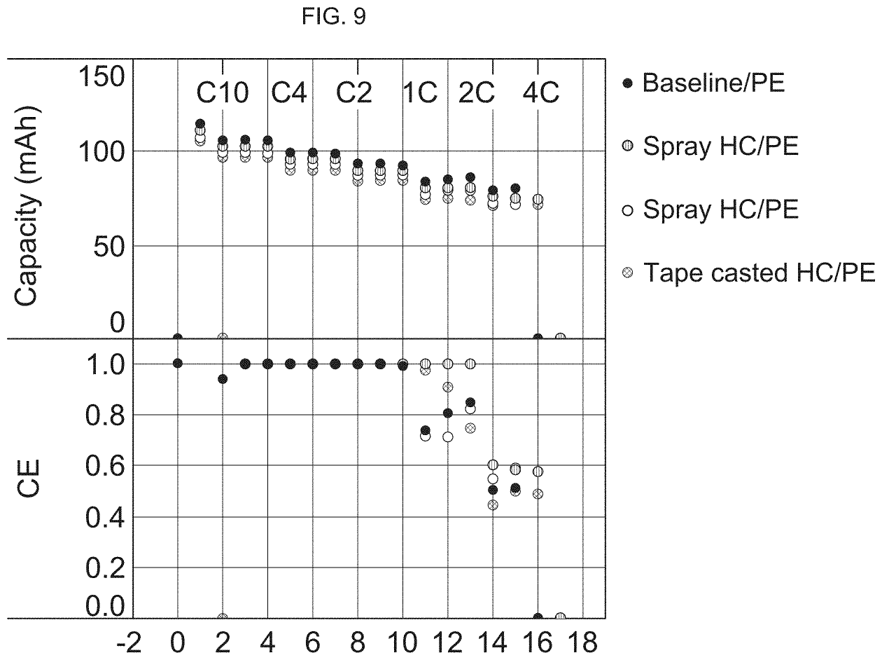

FIG. 9 is a graphical representation of capacity retention vs. number of cycles and C-rate in different electrochemical cell configurations. Each cell includes an NMC 811 cathode, a Li metal anode, and a polyethylene separator. The baseline case includes no coating on the separator, while other cases include hard carbon either sprayed or tape casted onto the separator. During the earlier cycles, the C-rate is low, and the C-rate increases throughout the 18 cycles. The cells with separators sprayed with hard carbon have about 99% coulombic efficiency at 1 C while the baseline case has decreased to a coulombic efficiency of about 75%. The sprayed hard carbon cases survived after three cycles at 4 C while the baseline case failed at the first cycle at 4 C.

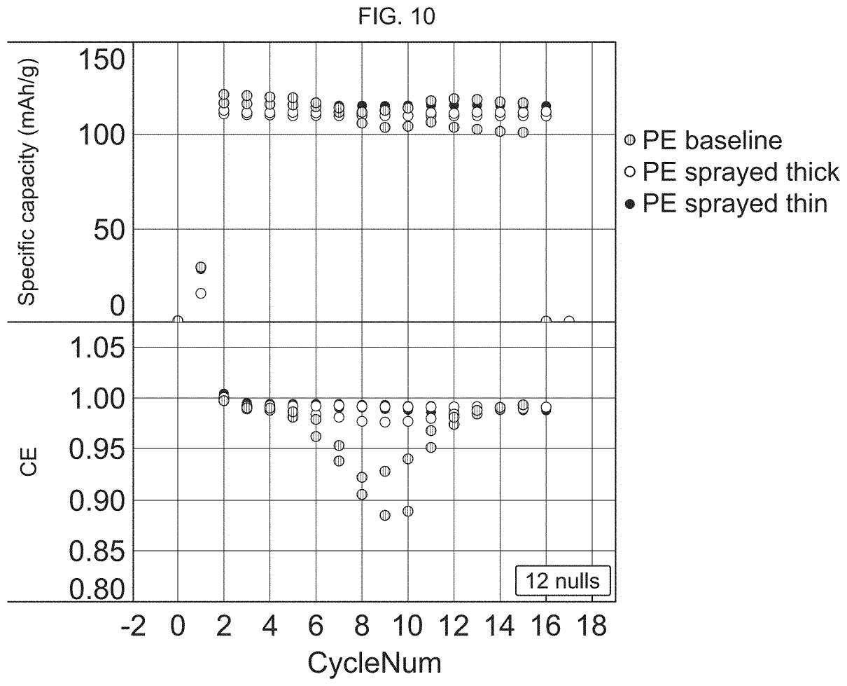

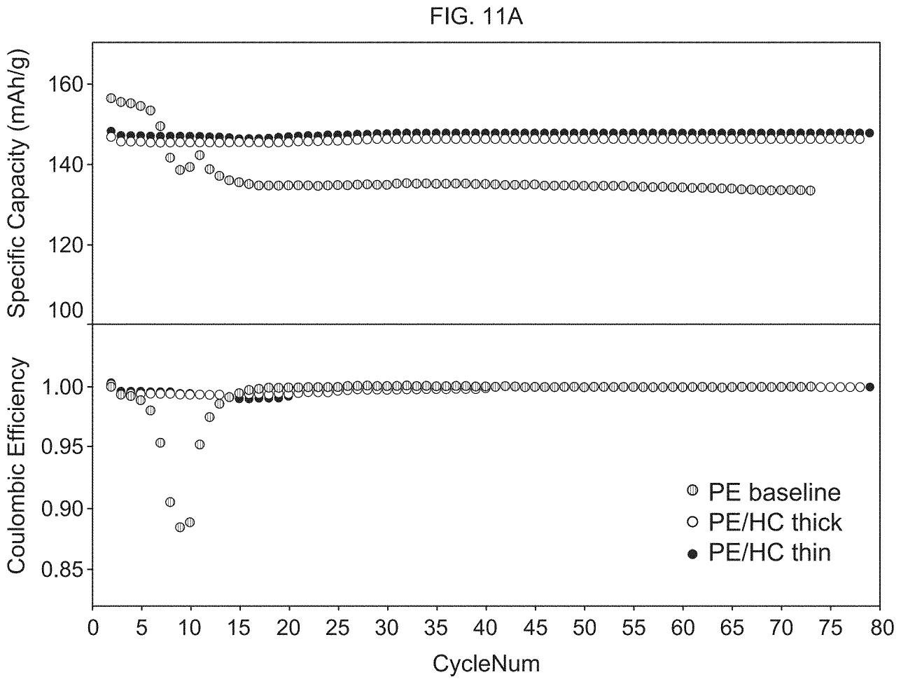

FIG. 10 is a graphical representation of capacity retention vs. number of cycles and C-rate in different electrochemical cell configurations. Each cell includes an NMC 811 cathode, graphite anode, and a polyethylene separator. The baseline cell includes no coating on the separator, while other cells include separators sprayed with a thin coating (i.e., <5 μm) of hard carbon and a thick coating (i.e., about 10 μm) of hard carbon on the anode side. At a 1.4 C charge rate, the coulombic efficiency of the baseline case drops to about 90% and then recovers, while the hard carbon coated cases are stable at around 99.5%-99.9%. The baseline case capacity fades faster than the capacities of the cells with hard carbon coating.

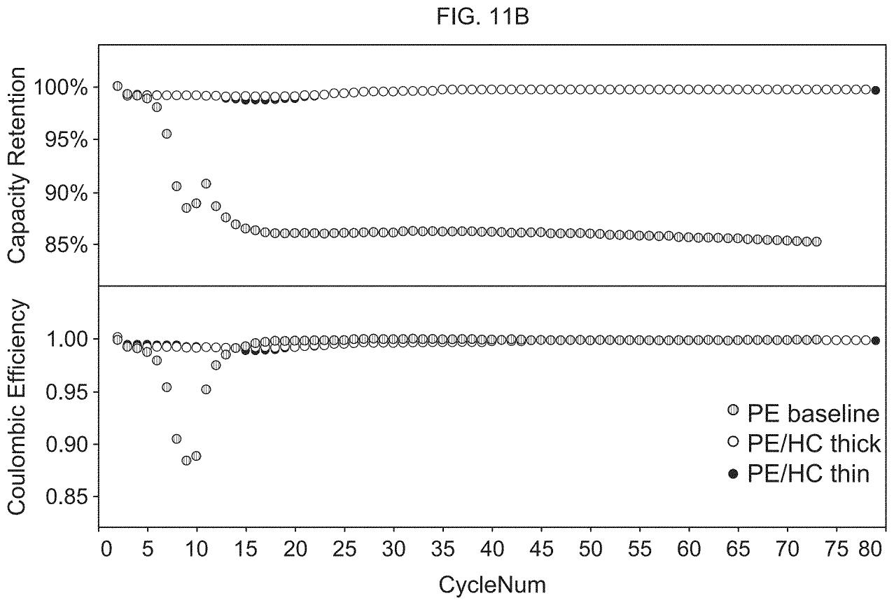

FIGS. 11A-11B are graphical representations of capacity retention vs. number of cycles in different electrochemical cells. The top plot in FIG. 11A shows absolute capacity per cycle, while the top plot in plot 11B shows capacity retention percentage, relative to the first cycle. FIGS. 11A-11B include an electrochemical cell with an NMC 811 cathode, a semi-solid graphite anode, and a conventional polyethylene separator compared to electrochemical cells with an NMC 811 cathode, a semi-solid graphite anode and polyethylene separators coated with a thin coating (i.e., less than 5 μm) and a thick coating (i.e., about 10 μm) of hard carbon on the anode side. The baseline case has an initial decline in capacity during the first few cycles and then a slight recovery, before fading to about 85% of its initial capacity. The polyethylene separators with hard carbon coating maintain about 98%-99% of their initial capacity through 80 cycles. The bottom plot in both FIG. 11A and FIG. 11B shows an initial decline in coulombic efficiency of the baseline case and recovery around the 12^{th} cycle. The bottom plot also shows the cells with hard carbon coating on the separator maintaining high coulombic efficiency throughout.

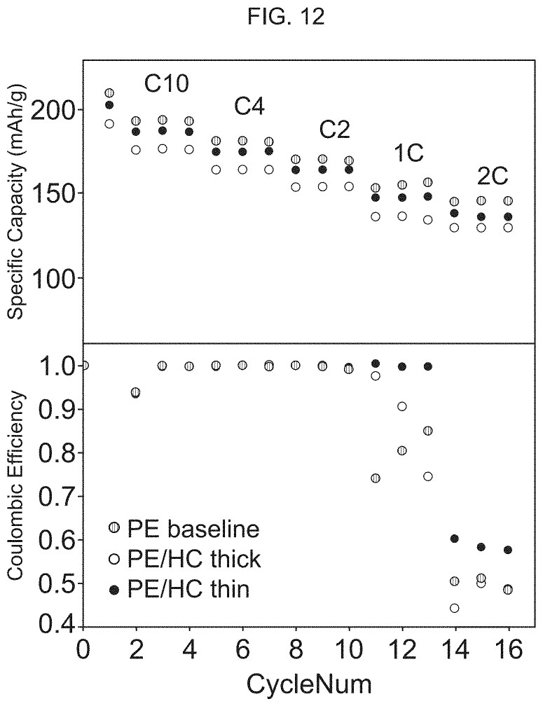

FIG. 12 is a graphical representation of capacity retention vs. number of cycles and C-rate in different electrochemical cell configurations. FIG. 12 includes an electrochemical cell with an NMC 811 cathode, a semi-solid graphite anode, and a conventional polyethylene separator compared to electrochemical cells with an NMC 811 cathode, a semi-solid graphite anode and polyethylene separators coated with a thin coating (i.e., less than 5 μm) and a thick coating (i.e., about 10 μm) of hard carbon on the anode side. During the earlier cycles, the C-rate is low, and the C-rate increases throughout the 16 cycles. The cell with a separator sprayed with a thin coating (i.e., less than 5 μm) of hard carbon have about a 99% coulombic efficiency at 1 C while the baseline case has decreased to a coulombic efficiency of about 75%.

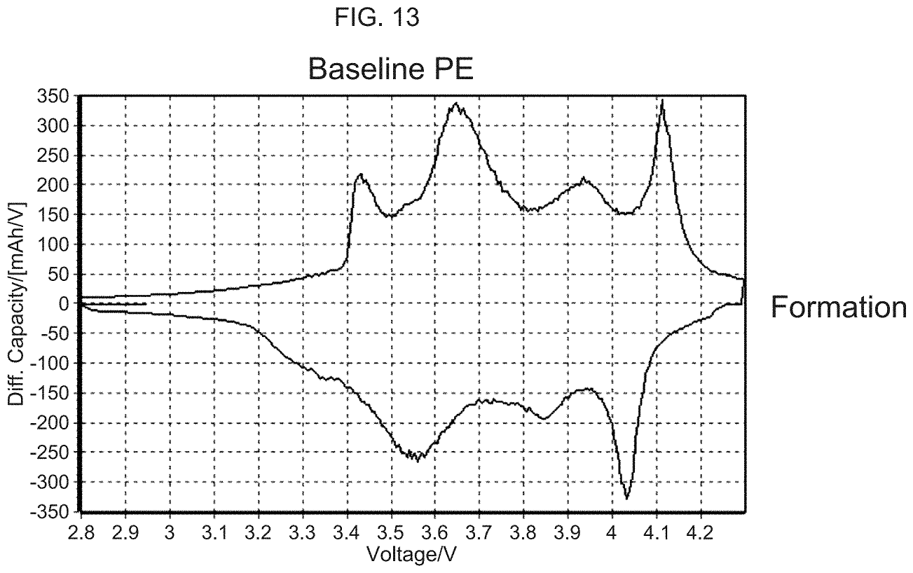

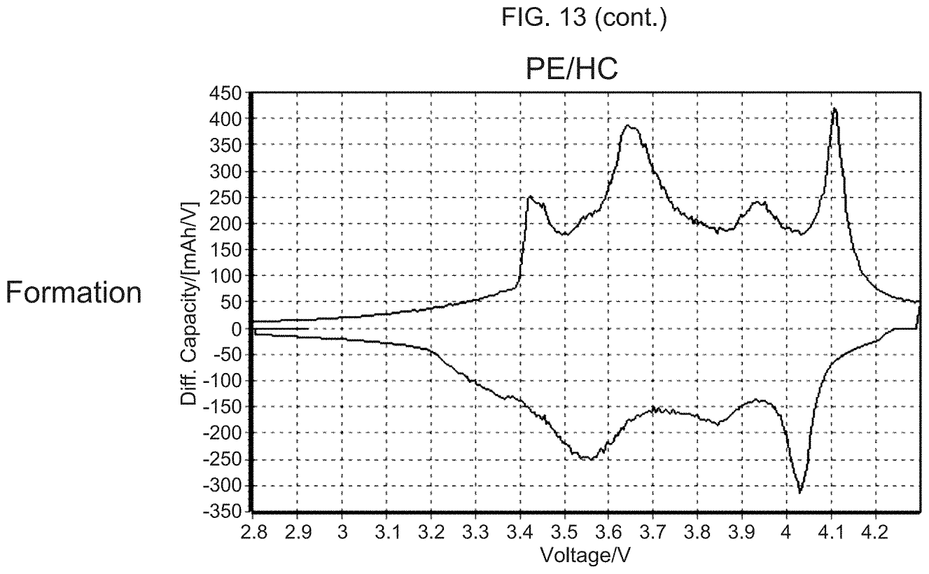

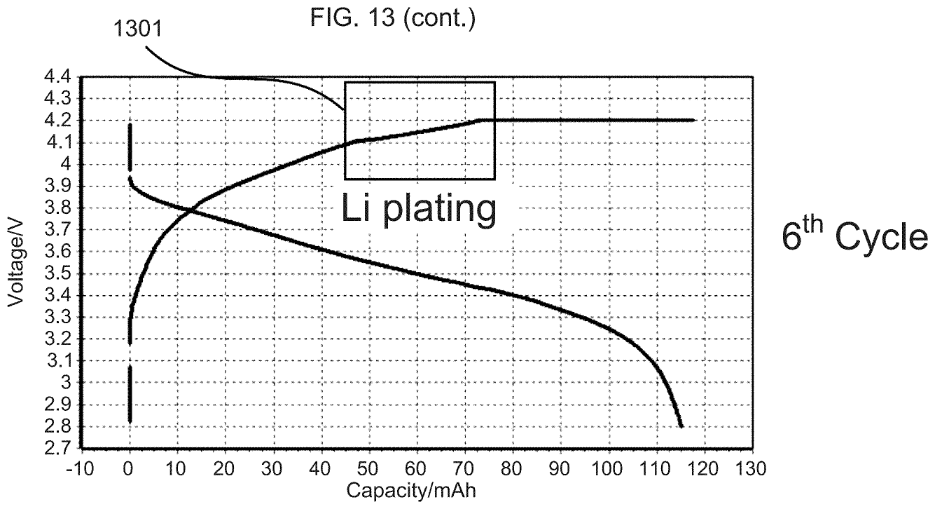

FIG. 13 is a graphical representation of dQ/dV and voltage profile comparisons between different electrochemical cell configurations. The plot on the top left shows differential capacity vs. voltage for a baseline case with an uncoated polyethylene separator. The bottom left plot shows a voltage vs. capacity plot for charging and discharging of the baseline case. The top right plot shows differential capacity vs. voltage for a cell with a polyethylene separator coated with hard carbon. The bottom right plot shows a voltage vs. capacity plot for charging and discharging of a cell with a polyethylene separator coated with hard carbon. Section 1301 on the bottom left plot shows a lag in voltage increase during charging. This is due to lithium plating and irreversible capacity loss. The plot on the bottom right does not have this anomaly and is charging more efficiently.

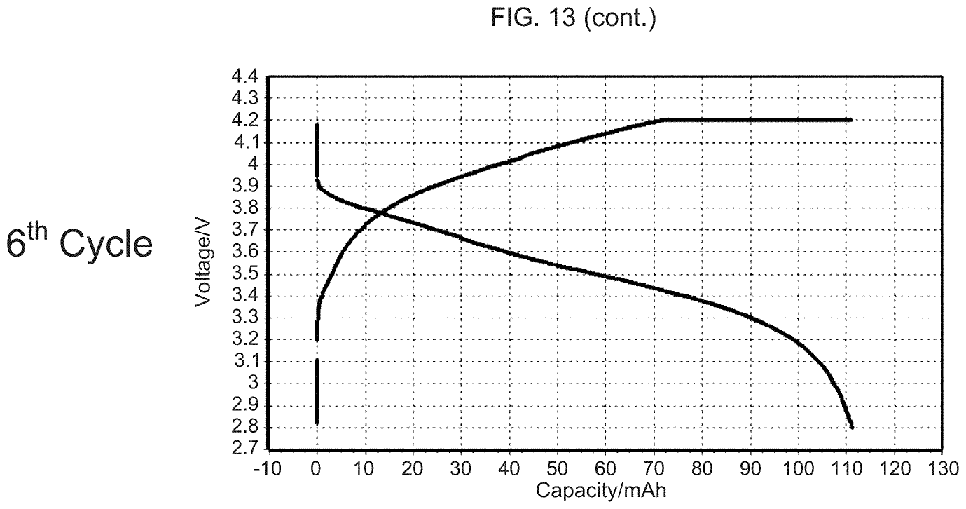

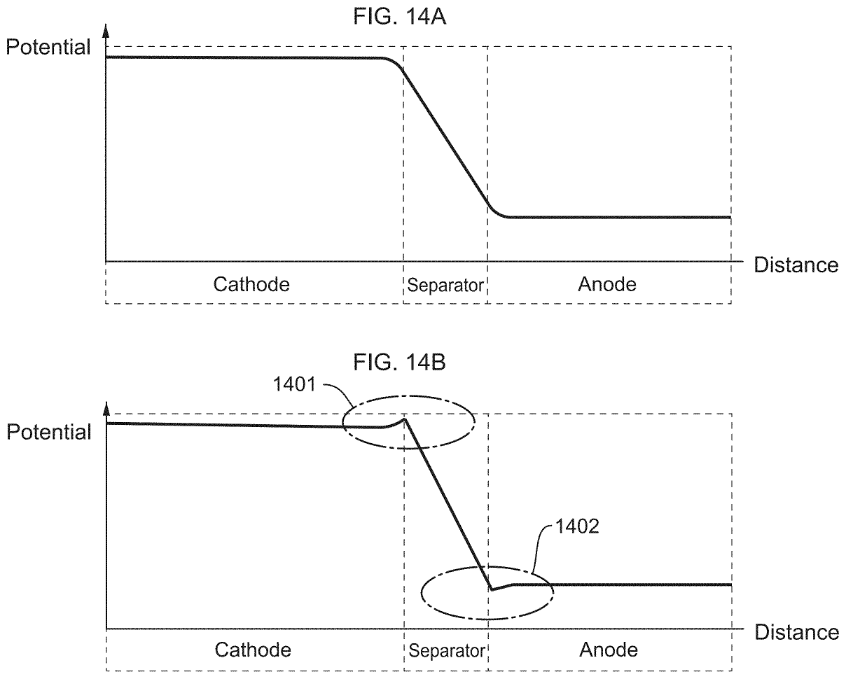

FIGS. 14A-14B are qualitative plots of potential vs. distance of electrochemical cells with semi-solid cathodes during discharge and rapid charge. FIG. 14A shows a qualitative plot of potential vs. distance during discharge. FIG. 14B shows a qualitative plot of potential vs. distance during rapid charge, particularly at a high state of charge. As shown in FIG. 14B, a high potential region 1401 develops at an interface between the semi-solid cathode and the separator during rapid charge, particularly at a high state of charge. A low potential region 1402 develops at an interface between the anode and the separator during rapid charge, particularly at a high state of charge. The high potential region 1401 and the low potential region 1402 can lead to dendrite formation at the interface between the semi-solid cathode and the separator or the interface between the anode and the separator. A semi-solid cathode has a higher diffusivity than a conventional (solid) cathode. This leads to a higher surface overpotential at the interface between the semi-solid cathode and the separator. In some embodiments, the semi-solid cathode can be thicker than a conventional cathode. The thickness of the semi-solid cathode can hinder the electronic conductivity of the semi-solid cathode at the surface of the semi-solid cathode adjacent to the separator. This issue can be addressed by using a semi-solid cathode material that is stable at a high voltage. A semi-solid cathode material that is stable at a high voltage can reduce surface overpotential at the interface between the semi-solid cathode and the separator. These overpotential losses can also be reduced by coating the semi-solid cathode or the separator with a highly conductive material at the interface between the semi-solid cathode and the separator. Examples of these mechanisms of reduction of overpotential losses are described above in the electrochemical cell 100 with reference to FIG. 1.

In some embodiments, the low potential region 1402 can be mitigated by coating the separator and/or the anode at the interface between the anode and the separator. In some embodiments, the coating can include a hard carbon. Examples of these coatings are described above in the electrochemical cell 100, 200, 300, 400, and 500 with reference to FIG. 1, FIG. 2, FIG. 3, FIG. 4, and FIGS. 5A-5B.

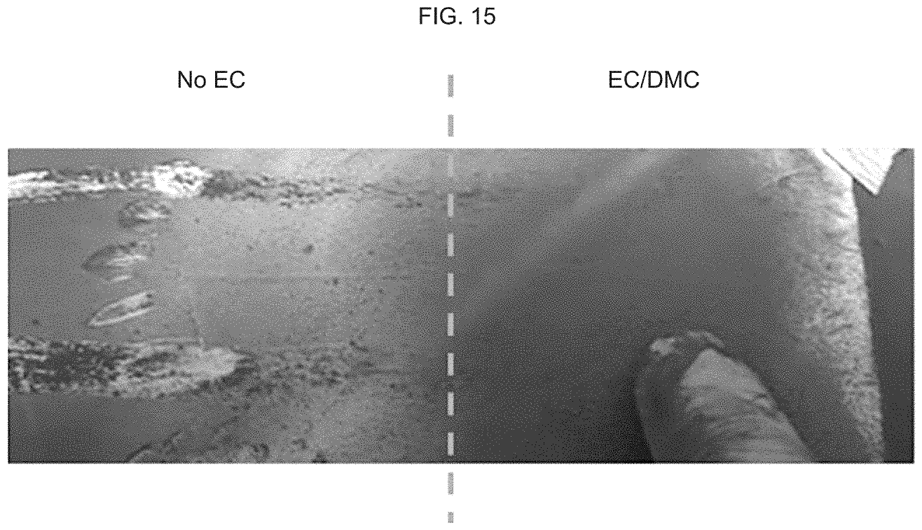

FIG. 15 shows a photographic comparison of hard carbon coating on a separator without a binder and with a binder. As shown in the image on the left, the hard carbon coating falls off the separator in the absence of any binder processing. In the image on the right, the hard carbon has been treated with EC dissolved in DMC prior to being applied to the separator. After drying, the hard carbon adheres to the separator much more stably than in the absence of a binder.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell, comprising:
an anode disposed on an anode current collector;
a cathode disposed on a cathode current collector;
a separator disposed between the anode and the cathode, the separator having a first side adjacent to the cathode and a second side adjacent to the anode; and
a coating layer disposed on the separator, the coating layer configured to reduce dendrite formation in the electrochemical cell.

2. The electrochemical cell of claim 1, wherein the coating layer includes hard carbon.

3. The electrochemical cell of claim 1, wherein the coating layer has a thickness between about 100 nm and about 20 μm.

4. The electrochemical cell of claim 1, wherein the coating layer is disposed on the first side of the separator.

5. The electrochemical cell of claim 4, wherein the coating layer is a first coating layer, the electrochemical cell further comprising a second coating layer, the second coating layer disposed on the second side of the separator.

6. The electrochemical cell of claim 5, wherein the second coating layer includes Al₂O₃.

7. The electrochemical cell of claim 5, wherein the second coating layer has a thickness between about 10 nm and about 2 μm.

8. The electrochemical cell of claim 1, wherein the anode and/or the cathode includes a semi-solid electrode material, the semi-solid electrode material including an active material and a conductive material in a liquid electrolyte.

9. The electrochemical cell of claim 1, wherein the coating layer includes an active material.

10. The electrochemical cell of claim 9, wherein the active material includes at least one of lithium manganese iron phosphate, lithium iron phosphate, lithium manganese oxide, or lithium nickel dioxide doped with manganese.

11. An electrode, comprising:
a current collector;
a semi-solid electrode material disposed on the current collector;
a separator; and
a coating layer disposed on a first side of the separator, the coating layer including hard carbon,
wherein the semi-solid electrode material is disposed on the first side of the separator, and
wherein the coating layer includes hard carbon in an amount sufficient to reduce overpotential losses at an interface between the separator and the semi-solid electrode material by at least about 10%.

12. The electrode of claim 11, wherein the coating layer has a thickness between about 100 nm and about 20 μm.

13. The electrode of claim 11, wherein the electrode material includes a semi-solid electrode material, the semi-solid electrode material including an active material and a conductive material in a liquid electrolyte.

14. The electrode of claim 11, wherein the coating material further includes a binder, the binder configured to prevent the coating material from detaching from the separator.

15. The electrode of claim 14, wherein the binder includes ethylene carbonate.

16. An electrochemical cell, comprising:
an anode disposed on an anode current collector;
a semi-solid cathode disposed on a cathode current collector;
a separator disposed between the anode and the cathode, the separator having a first side adjacent to the anode and a second side adjacent to the cathode; and
a coating layer disposed at an interface between the separator and the semi-solid cathode, the coating layer having a conductivity sufficient to reduce overpotential at the interface between the separator and the semi-solid cathode by at least about 10%.

17. The electrochemical cell of claim 16, wherein the coating layer includes hard carbon.

18. The electrochemical cell of claim 16, wherein the coating layer includes at least about 90% hard carbon by mass.

19. The electrochemical cell of claim 16, wherein the coating layer has a thickness between about 100 nm and about 20 μm.

20. The electrochemical cell of claim 16, wherein the coating layer is a first coating layer, the electrochemical cell further comprising:
a second coating layer disposed at an interface between the separator and the anode.

21. The electrochemical cell of claim 20, wherein the second coating layer includes Al₂O₃.

22. The electrochemical cell of claim 16, wherein the coating layer has a conductivity sufficient to reduce overpotential at the interface between the separator and the semi-solid cathode by at least about 20%.

23. An electrochemical cell, comprising:
an anode disposed on an anode current collector;
a semi-solid cathode disposed on a cathode current collector; and
a separator disposed between the anode and the cathode, the separator having a first side adjacent to the anode and a second side adjacent to the cathode,
wherein the semi-solid cathode is stable at a voltage sufficient to reduce overpotential at an interface between the separator and the semi-solid cathode by at least about 10%.

24. The electrochemical cell of claim 23, wherein the semi-solid cathode includes a layer of conductive material at the interface between the separator and the semi-solid cathode.

25. The electrochemical cell of claim 24, wherein the conductive material includes hard carbon.

26. The electrochemical cell of claim 24, wherein layer of conductive material has a thickness between about 100 nm and about 20 μm.

27. A method, comprising:
disposing an electrode material onto a current collector;
mixing a hard carbon coating with a solvent to form a coating mixture;
applying the coating mixture to a first side of a separator;
drying the coating mixture to form a coating layer; and
disposing electrode material onto the first side of the separator to form an electrode.

28. The method of claim 27, wherein the electrode is a first electrode, the method further comprising:
disposing a second electrode onto a second side of the separator to form an electrochemical cell, the second side of the separator opposite the first side of the separator.

29. The method of claim 28, further comprising:
coating the second side of the separator with a coating material.

30. The method of claim 29, wherein the coating material includes Al₂O₃.

31. The method of claim 27, wherein the drying vaporizes substantially all of the binder.

32. The method of claim 27, wherein the binder includes ethylene carbonate.

33. The method of claim 27, wherein the solvent includes at least one of ethyl methyl carbonate or dimethyl carbonate.

34. The method of claim 27, wherein the applying is via an inkjet.

35. The method of claim 27, wherein the coating mixture further includes a binder.

36. The method of claim 27, wherein the coating mixture further includes a surfactant.
